(19) United States
(12) Patent Application Publication
(10) Pub. No.: US 2025/0356305 A1
(43) Pub. Date: Nov. 20, 2025

(54) METHOD FOR STORING AND/OR TRANSPORTING TEMPERATURE-SENSITIVE MATERIALS AND SYSTEM FOR USE THEREIN

(71) Applicant: Cold Chain Technologies, LLC, Franklin, MA (US)

(72) Inventors: Theodore R. Smith, Watertown, MA (US); Paul T. Della Villa, Pawtucket, RI (US)

(21) Appl. No.: 19/210,242

(22) Filed: May 16, 2025

Related U.S. Application Data
(60) Provisional application No. 63/648,982, filed on May 17, 2024.

(51) Int. Cl. G06Q 10/0832; F25D 11/00; G06Q 10/083; G06Q 10/0835

(52) U.S. Cl. CPC G06Q 10/0832; F25D 11/006; G06Q 10/0835; G06Q 10/08355

(57) ABSTRACT

Method for storing and/or transporting temperature-sensitive materials. In one embodiment, the method involves predicting whether a given passive thermal shipping system will maintain a payload within a desired temperature range over its entire transport/delivery route. To this end, thermal capacitance data is compiled for the shipping system at a plurality of temperatures spanning a broad range of potential ambient temperatures to which the shipping system may be exposed. In addition, forecasted ambient temperature data is obtained for a plurality of time intervals spanning the transport/delivery route. An effective ambient temperature, based on the forecasted ambient temperature, as well as rolling and cumulative averages, is then determined at each of the various time intervals. Using the effective ambient temperature, the thermal capacitance is determined from the compiled data and is compared to the cumulative absorbed energy. The shipping system fails when the cumulative absorbed energy exceeds the thermal capacitance.

### CROSS-REFERENCE TO RELATED APPLICATIONS

The present application claims the benefit under 35 U.S.C. 119(e) of U.S. Provisional Patent Application No. 63/648,982, inventors Theodore R. Smith et al., filed May 17, 2024, the disclosure of which is incorporated herein by reference.

### BACKGROUND OF THE INVENTION

The present invention relates generally to the storing and/or transporting of temperature-sensitive materials and relates more particularly to a novel method for storing and/or transporting temperature-sensitive materials and to a system for use therein.

There is a continuing need for systems that can maintain a payload of temperature-sensitive materials within a desired temperature range for an extended period of time. For example, many pharmaceuticals, biological materials, medical devices, foods, beverages, and other temperature-sensitive materials must be maintained within a particular temperature range (such as, for example, −90° C. to −60° C.; −25° C. to −15° C.; +2° C. to +8° C.; +15° C. to +25° C.) in order to prevent the spoilage of such materials. As can readily be appreciated, the maintenance of such materials within a desired temperature range while such materials are being transported and/or stored can be challenging. One way in which such temperature maintenance may be achieved is by transporting and/or storing such materials in active temperature-control devices, such as electrically-powered refrigeration units or the like. However, as can be appreciated, such active temperature-control devices add considerable expense to transportation and/or storage costs.

An alternative approach to temperature maintenance during transportation and/or storage of a payload of temperature-sensitive materials is to use a passive thermal shipping system that comprises an insulated container and preferably one or more passive temperature-control members. The passive temperature-control members may be packaged passive temperature-control members, such as, but not limited to, ice packs, gel packs, refrigerant bricks, or the like, or may be unpackaged passive temperature-control members, such as loose dry ice, loose wet ice, or the like. In many cases, the payload of temperature-sensitive materials is housed within a product box (sometimes alternatively referred to as “a payload box”) that, in turn, is housed within the insulated container along with the one or more passive temperature-control members. The thermal shipping system may additionally include one or more other components, such as, but not limited to, an outer retaining box, a liner, additional insulation, and dunnage.

As can be appreciated, in order for a thermal shipping system to serve its intended purpose, the thermal shipping system must be capable of keeping its payload within a desired temperature range for the entire duration of its expected storage and/or transit time period. Otherwise, the payload will spoil while the thermal shipping system is in transit and/or before storage of the payload is complete. As can be appreciated, the ability of a thermal shipping system to fulfill its intended purpose may be affected by a number of factors, illustrative examples of which may include one or more of the following: the type of passive temperature-control member that is used, the quantity of passive temperature-control member that is used, the temperature at which the passive temperature-control member is preconditioned, the acceptable range of temperatures at which the payload should be maintained, the type of insulated container that is used, the ambient (i.e., external environment) temperature(s) to which the thermal shipping system is exposed, the size of the payload, and the length of the time period that the thermal shipping system will be used for storage and/or transport.

Because of the above-noted importance of maintaining a payload within its desired temperature range for the entire duration of its storage and/or transit period, various efforts have been undertaken to devise computer-aided models for predicting how long a payload in a given thermal shipping system may be maintained within its desired temperature range while being exposed to the ambient temperatures that are anticipated for the storage and/or transit period. In this manner, for example, a determination may be made as to whether a given thermal shipping system is expected to maintain its payload within its desired temperature range for the entire duration of its storage and/or transit period.

Although existing models of the aforementioned type are believed to have some predictive value, the present inventors believe that improvements to such models are needed.

Documents that may be of interest may include the following, all of which are incorporated herein by reference: U.S. Pat. No. 10,909,492 B1, inventor Reinhardt, issued Feb. 2, 2021; U.S. Pat. No. 10,605,674 B1, inventors Holbrook et al., issued Mar. 31, 2020; U.S. Pat. No. 9,981,797 B2, inventors Aksan et al., issued May 29, 2018; U.S. Pat. No. 8,600,903 B2, inventor Eller, issued Dec. 3, 2013; U.S. Pat. No. 8,375,730 B2, inventors Haarmann et al., issued Feb. 19, 2013; U.S. Pat. No. 8,326,679, inventors Rowe et al., issued Dec. 4, 2012; U.S. Patent Application Publication No. US 2019/0301794 A1, inventor Esser, published Oct. 3, 2019; U.S. Patent Application Publication No. US 2019/0137162 A1, inventors Ominsky et al., published May 9, 2019; U.S. Patent Application Publication No. US 2018/0086539 A1, inventors Aksan et al., published Mar. 29, 2018; U.S. Patent Application Publication No. US 2017/0300855 A1; inventors Lund et al., published Oct. 19, 2017; U.S. Patent Application Publication No. US 2017/0083856 A1, inventor Song, published Mar. 23, 2017; U.S. Patent Application Publication No. US 2016/0338908 A1, inventors Rice et al., published Nov. 24, 2016; U.S. Patent Application Publication No. US 2013/0325737 A1, inventors Smalling et al., published Dec. 5, 2013; U.S. Patent Application Publication No. US 2012/0305435 A1, inventors Matta et al., published Dec. 6, 2012; U.S. Patent Application Publication No. US 2012/0248101 A1, inventors Tumber et al., published Oct. 4, 2012; U.S. Patent Application Publication No. US 2012/0197810 A1, inventors Haarmann et al., published Aug. 2, 2012; U.S. Patent Application Publication No. 2010/0299278 A1, inventors Kriss et al., Nov. 25, 2010; U.S. Patent Application Publication No. US 2008/0291033, inventor Aghassipour, published Nov. 27, 2008; U.S. patent application Ser. No. 16/246,435, inventors Chasteen et al., filed Jan. 11, 2019; World Health Organization, “Transport route profiling qualification,” published 2015; WHO Press; WHO Technical Report Series, No. 961, Annex 5, Supplement 14, pages 1-32; and Li, “Cold-chain packaging: a new, holistic approach to packaging optimization and small-package cost management,” UPS, pages 1-16 (2014).

### SUMMARY OF THE INVENTION

It is an object of the present invention to provide a novel method for storing and/or transporting temperature-sensitive materials.

According to one aspect of the invention, there is provided a method for storing and/or transporting temperature-sensitive materials, the method comprising the steps of (a) selecting a first passive thermal shipping system, the first passive thermal shipping system comprising an insulated container adapted to hold the temperature-sensitive materials; (b) compiling thermal capacitance data for the first passive thermal shipping system, the thermal capacitance data being obtained at a plurality of temperatures spanning a range of potential ambient temperatures to which the first passive thermal shipping system may be subjected during a duration of storage and/or transport; (c) obtaining forecasted ambient temperatures to which the first passive thermal shipping system will be subjected during the duration of storage and/or transport, the forecasted ambient temperatures being spaced apart at time intervals throughout the duration of storage and/or transport; (d) determining a failure time for the first passive thermal shipping system, wherein said failure time is a first occurrence of cumulative absorbed energy for the first passive thermal shipping system exceeding thermal capacitance for the first passive thermal shipping system; (e) comparing the failure time for the first passive thermal shipping system to the duration of storage and/or transport, whereby, if the failure time is at least the duration of storage and/or transport, the first passive thermal shipping system is adequate for use, and, if the failure time is less than the duration of storage and/or transportation, the first passive thermal shipping system is inadequate for use; (f) if the first passive thermal shipping system is inadequate for use, repeating steps (b), (d), and (e), as well as step (c) if a different transport/delivery route is to be taken than that of the first passive thermal shipping system, for one or more additional passive thermal shipping systems until an adequate passive thermal shipping system is identified; and (g) storing and/or transporting the temperature-sensitive materials using the adequate passive thermal shipping system.

In a more detailed feature of the invention, the first passive thermal shipping system may further comprise at least one passive temperature-control member disposed within the insulated container, and the at least one passive temperature-control member may comprise a packaged passive temperature-control member.

In a more detailed feature of the invention, the thermal capacitance data may be obtained by determining the failure time for the first passive thermal shipping system at each of the plurality of temperatures spanning the range of potential ambient temperatures to which the first passive thermal shipping may be subjected and then calculating thermal capacitance according to the following equation:

$$Thermal capacitance = ( {T}_{ambient} - {T}_{ref} ) * {t}_{failure}$$

wherein T_{ambient} represents ambient temperature, wherein T_{ref} represents a midpoint within a range of temperatures at which the payload is to be maintained, and wherein t_{failure} represents failure time at the ambient temperature.

In a more detailed feature of the invention, the thermal capacitance of step (d) may be determined at an effective temperature, and the effective temperature may be a weighted average of the forecasted ambient temperature, a rolling average of the forecasted ambient temperature, and a cumulative average of the forecasted ambient temperature.

In a more detailed feature of the invention, the effective temperature may be calculated by the following equation:

$${T}_{effective} = \frac{A * {T}_{Rollinq Averaqe} + B * {T}_{Cumulative Averaqe} + C * {T}_{Actual Ambient}}{A + B + C}$$

wherein T_{effective} represents the effective temperature, wherein T_{Rolling Average} represents the rolling average of forecasted ambient temperatures, wherein T_{Cumulative Average} represents the cumulative average of ambient temperatures, wherein T_{Actual Ambient} represents the actual forecasted ambient temperature, and wherein A, B, and C represent weight factors.

In a more detailed feature of the invention, the cumulative absorbed energy may be calculated by the following equation:

$$E ∼ {\int }_{0}^{{t}_{final}} Δ T ( t ) dt = {\int }_{0}^{{t}_{final}} {T}_{ambient} ( t ) - {T}_{ref} dt$$

wherein E is the cumulative absorbed energy up to and including a time interval, wherein t_{final} is the duration of time up to and including the time interval, wherein T_{ambient} is the forecasted ambient temperature at the time interval, and wherein T_{ref} is the midpoint of the desired temperature range for the payload.

In a more detailed feature of the invention, the failure time may be determined by calculating the cumulative absorbed energy at a first time interval, calculating the thermal capacitance at a first time interval, comparing the calculated cumulative absorbed energy at the first time interval to the calculated thermal capacitance at the first time interval, and, if the cumulative absorbed energy does not exceed the thermal capacitance, repeating the calculating and comparison of the cumulative absorbed energy and the thermal capacitance for one or more successive time intervals.

In a more detailed feature of the invention, the failure time may be determined by calculating each of the cumulative absorbed energy and the thermal capacitance at each time interval throughout the duration of storage and/or transportation, plotting profiles of the cumulative absorbed energy and the thermal capacitance as a function of time, and determining where the profiles intersect.

In a more detailed feature of the invention, the thermal capacitance data may include a series of intermediate thermal capacitances corresponding to temperatures between an initial temperature of the first passive thermal system and a final temperature of the first passive thermal system.

In a more detailed feature of the invention, the first passive thermal system may have a reference temperature, and the reference temperature may change over time as the cumulative absorbed energy exceeds the intermediate thermal capacitances.

In a more detailed feature of the invention, one or more of steps (a) through (f) may be performed using a computer.

In a more detailed feature of the invention, the method may further comprise the step of notifying a user whether the first passive thermal shipping system is adequate for use.

In a more detailed feature of the invention, the method may further comprise, after step (f) and before step (g), the steps of pre-conditioning the at least one passive temperature-control member, assembling the adequate passive thermal shipping system, and loading the payload into the adequate passive thermal shipping system.

In a more detailed feature of the invention, step (a) may be performed before step (b).

In a more detailed feature of the invention, step (b) may be performed before step (a).

According to another aspect of the invention, there is provided a method for evaluating a passive thermal shipping system, the method comprising the steps of (a) compiling thermal capacitance data for the passive thermal shipping system, the thermal capacitance data being obtained at a plurality of temperatures spanning a range of potential ambient temperatures to which the passive thermal shipping system may be subjected during use; (b) obtaining forecasted ambient temperatures to which the passive thermal shipping system will be subjected during use, the forecasted ambient temperatures being spaced apart at time intervals throughout the duration of use; (c) determining a failure time for the passive thermal shipping system, wherein said failure time is a first occurrence of cumulative absorbed energy for the passive thermal shipping system exceeding thermal capacitance for the passive thermal shipping system; and (d) comparing the failure time for the passive thermal shipping system to the duration of use, whereby, if the failure time is at least the duration of use, the passive thermal shipping system is adequate for use, and, if the failure time is less than the duration of use, the passive thermal shipping system is inadequate for use.

In a more detailed feature of the invention, the passive thermal shipping system may further comprise at least one passive temperature-control member disposed within the insulated container, and the at least one passive temperature-control member may comprise a packaged passive temperature-control member.

In a more detailed feature of the invention, the thermal capacitance data may be obtained by determining the failure time for the passive thermal shipping system at each of the plurality of temperatures spanning the range of potential ambient temperatures to which the passive thermal shipping may be subjected and then calculating thermal capacitance according to the following equation:

$$Thermal capacitance = ( {T}_{ambient} - {T}_{ref} ) * {t}_{failure}$$

wherein T_{ambient} represents ambient temperature, wherein T_{ref} represents a midpoint within a range of temperatures at which a payload is to be maintained, and wherein t_{failure} represents failure time at the ambient temperature.

In a more detailed feature of the invention, the thermal capacitance of step (c) may be determined at an effective temperature, and the effective temperature may be a weighted average of the forecasted ambient temperature, a rolling average of the forecasted ambient temperature, and a cumulative average of the forecasted ambient temperature.

In a more detailed feature of the invention, the effective temperature may be calculated by the following equation:

$${T}_{effective} = \frac{A * {T}_{Rollinq Averaqe} + B * {T}_{Cumulative Averaqe} + C * {T}_{Actual Ambient}}{A + B + C}$$

wherein T_{effective} represents the effective temperature, wherein T_{Rolling Average} represents the rolling average of forecasted ambient temperatures, wherein T_{cumulative Average} represents the cumulative average of ambient temperatures, wherein T_{Actual Ambient} represents the actual forecasted ambient temperature, and wherein A, B, and C represent weight factors.

In a more detailed feature of the invention, the cumulative absorbed energy may be calculated by the following equation:

$$E ∼ {\int }_{0}^{{t}_{final}} Δ T ( t ) dt = {\int }_{0}^{{t}_{final}} {T}_{ambient} ( t ) - {T}_{ref} dt$$

wherein E is the cumulative absorbed energy up to and including a time interval, wherein t_{final} is the duration of time up to and including the time interval, wherein T_{ambient} is the forecasted ambient temperature at the time interval, and wherein T_{ref} is the midpoint of the desired temperature range for the payload.

In a more detailed feature of the invention, the failure time may be determined by calculating the cumulative absorbed energy at a first time interval, calculating the thermal capacitance at a first time interval, comparing the calculated cumulative absorbed energy at the first time interval to the calculated thermal capacitance at the first time interval, and, if the cumulative absorbed energy does not exceed the thermal capacitance, repeating the calculating and comparison of the cumulative absorbed energy and the thermal capacitance for one or more successive time intervals.

In a more detailed feature of the invention, the failure time may be determined by calculating each of the cumulative absorbed energy and the thermal capacitance at each time interval throughout the duration of use, plotting profiles of the cumulative absorbed energy and the thermal capacitance as a function of time, and determining where the profiles intersect.

In a more detailed feature of the invention, the method may further comprise the step of notifying a user whether the first passive thermal shipping system is adequate for use.

In a more detailed feature of the invention, one or more of steps (a) through (d) are performed using a computer. According to still another aspect of the invention, there is provided a system for use in evaluating whether a passive thermal shipping system is suitable for storage and/or transportation of temperature-sensitive materials, the system comprising (a) a shipper evaluator, the shipper evaluator having a central controller; and (b) a compute device adapted for use by an inquiring party, the compute device being in electronic communication with the central controller, wherein shipment parameter data is uploaded onto the central controller using the compute device, the shipment parameter data comprising a selected passive thermal shipping system, a shipment origin, and a shipment destination; (c) wherein the central controller retrieves data relating to an intended shipment travel path based on the shipment origin, the shipment destination, and the selected passive thermal shipping system; (d) wherein the central controller retrieves thermal capacitance data from one or more temperature sweep tables; (e) wherein the central controller retrieves one or more reference temperatures, a rolling average period, and weight factors for use in determining an effective ambient temperature from one or more system variable tables; (f) wherein the central controller retrieves forecasted ambient temperature data relating to the intended shipment travel path; (g) wherein the central controller calculates an effective ambient temperature at a plurality of time intervals along the intended shipment travel path; (h) wherein the central controller determines a thermal capacitance at a plurality of time intervals along the intended shipment path; and (i) wherein the central controller determines a failure time for the selected passive thermal shipping system, wherein said failure time is a first occurrence of cumulative absorbed energy for the selected passive thermal shipping system exceeding thermal capacitance for the selected passive thermal shipping system, wherein thermal capacitance is based on the effective ambient temperature.

For purposes of the present specification and claims, various relational terms like “top,” “bottom,” “proximal,” “distal,” “upper,” “lower,” “front,” and “rear” may be used to describe the present invention when said invention is positioned in or viewed from a given orientation. It is to be understood that, by altering the orientation of the invention, certain relational terms may need to be adjusted accordingly.

Additional objects, as well as features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. These drawings are not necessarily drawn to scale, and certain components may have undersized and/or oversized dimensions or may be shown in a simplified form for purposes of explication. In the drawings wherein like reference numerals represent like parts:

FIG. 1 is a graphical representation of the area-under-the-curve energy for a passive thermal shipping system that is subjected to variable ambient temperatures over a period of time;

FIG. 2 is a flowchart depicting a first embodiment of a method for storing and/or transporting temperature-sensitive materials according to the present invention;

FIG. 3 is a partly exploded perspective view of an exemplary passive thermal shipping system suitable for use in the method of FIG. 2;

FIG. 4 is a flowchart depicting a second embodiment of a method for storing and/or transporting temperature-sensitive materials according to the present invention;

FIG. 5 is a simplified schematic representation of one embodiment of a system for use in performing the method of FIG. 2, the system being constructed according to the present invention;

FIG. 6 is a graphic representation of area-under-the-curve calculations for a sample passive thermal shipping system subjected to different constant ambient temperatures, as discussed in Example 2;

FIG. 7 is a graphic representation of the failure energy limit for the aforementioned sample passive thermal shipping system, as discussed in Example 4;

FIG. 8 is a graphic representation of the profile energy for the aforementioned sample passive thermal shipping system, as discussed in Example 5;

FIG. 9 is a graphic representation of profile energy as a function of time for the aforementioned sample passive thermal shipping system, as discussed in Example 5; and

FIG. 10 is a graphic representation comparing the failure energy limit to the profile energy for the aforementioned sample passive thermal shipping system, as discussed in Example 6.

### DETAILED DESCRIPTION OF THE INVENTION

As noted above, it is important that temperature-sensitive materials, such as, but not limited to, various types of pharmaceuticals, biological materials, medical devices, foods, beverages, and the like, be maintained within a desired temperature range for the entire period of time that such temperature-sensitive materials are stored and/or transported. As can be appreciated, when the temperature-sensitive materials in question are stored and/or transported using a thermal shipping system of the type that comprises an insulated container and one or more passive temperature-control members, the period of time that the temperature-sensitive materials may be safely maintained within the desired temperature range is finite. Typically, the period of time lasts anywhere from a few hours up to 4-5 days, depending, in part, on the particular type of passive thermal shipping system that is used. Additionally, another factor that impacts the duration of such a period of time is the ambient (i.e., external environmental) temperatures to which the passive thermal shipping system is exposed. As a result, for example, two identical passive thermal shipping systems carrying identical payloads of temperature-sensitive materials may provide substantially different durations of thermal protection to their respective payloads if one system is exposed to ambient temperatures that deviate only insignificantly from the desired temperature range whereas the other system is exposed to ambient temperatures that deviate markedly from the desired temperature range, with the former system providing a comparatively longer period of thermal protection and the latter system providing a comparatively shorter period of thermal protection.

As can be appreciated, if the duration of thermal protection that is provided by a passive thermal shipping system is less than the period of time that is needed for storage and/or transportation of the payload, the payload will experience a thermal excursion (i.e., a temperature outside of the desired temperature range). In many cases, such a thermal excursion may render the payload partially or completely unusable; thus, the time when such a thermal excursion occurs is often referred to as when the passive thermal shipping system “fails,” and the duration of time to such a thermal excursion is often referred to as the “failure time.” As can be appreciated, it would be useful to be able to predict how long a given passive thermal shipping system can provide thermal protection to a payload that is exposed to a specific set of anticipated ambient temperatures before the passive thermal shipping system fails. In this manner, if the predicted period of thermal protection (or failure time) is less than the expected storage and/or transit time, corrective action may be taken, such as, but not limited to, one or more of the following: increasing the quantity of passive temperature-control members, changing the type of passive temperature-control members, changing the temperature at which the passive temperature-control members are preconditioned, changing the arrangement of passive temperature-control members within the insulated container, changing the type of insulated container, and changing the route over which the passive thermal shipping system may travel and, in so doing, changing the ambient temperatures to which the passive thermal shipping system is expected to be exposed.

Although computer-aided modeling techniques currently exist for predicting the failure time of a passive thermal shipping system, such techniques are time-consuming to perform. Accordingly, one objective of the present invention is to provide a computer-aided modeling technique that can be run in a fraction of the time of existing techniques.

Therefore, according to one aspect of the invention, there is provided a new computer-aided modeling technique that addresses at least some of the shortcomings with existing modeling techniques. Without wishing to be limited to any particular theory of the invention, a brief discussion of the present modeling technique is provided below.

The present technique makes certain assumptions about the amount of heat that enters a passive thermal shipping system based on the ambient temperature. In particular, the present technique assumes that a certain amount of heat can enter or leave the system before the passive thermal shipping system is no longer at a desired temperature. This assumption allows one to predict the time when failure occurs if the ambient temperature is known.

Additionally, the present technique also assumes that the rate of heat transfer via conduction is proportional to the temperature difference (ΔT) between two points in space. In a passive thermal shipping system, conduction through the insulation is the most significant source of heat transfer. One can make an educated guess about the temperature difference between the interior and exterior spaces relative to the insulation. First, one can assume a certain temperature for the inside space of the passive thermal shipping system (also sometimes referred to herein as “the reference temperature”). This is a good assumption because the function of the passive thermal shipping system is to maintain the interior space at a fixed temperature. Therefore, the temperature for the space inside the passive thermal shipping system may be assumed to be the temperature at which the payload is to be maintained. One can also assume that the temperature for the exterior space matches the ambient temperature. Knowing both the interior and exterior temperatures allows one to determine the temperature difference between these two spaces.

In addition, at least initially, one can assume that the ambient temperature is constant. Based on this assumption, the temperature difference between the interior and exterior spaces should also be constant. Since the rate of heat transfer is proportional to the temperature difference, the total heat entering the system is proportional to the temperature difference multiplied by the time exposed to that temperature difference. This relationship is reflected by Equation 1 below.

$$E ∼ Δ T * t \qquad ( 1 )$$

wherein E represents energy, wherein ΔT represents the temperature difference between the interior and exterior spaces, and wherein t represents time.

If, however, the ambient temperature is not constant, which is typically the case when a thermal shipping system is transported along an actual transport/delivery route, one can, nevertheless, still determine the heat entering the system by integration, as shown by Equation 2 below, wherein E represents energy, wherein ΔT represents the temperature difference between the temperature of the interior space (or Tᵢₙₜₑᵣᵢₒᵣ) and the temperature of the exterior space (or T_{ambient}), and wherein t_{final} represents the total time that has elapsed.

$$E ∼ {\int }_{0}^{{t}_{final}} Δ T ( t ) dt = {\int }_{0}^{{t}_{final}} {T}_{ambient} ( t ) - {T}_{interior} dt \qquad ( 2 )$$

According to one embodiment, Tᵢₙₜₑᵣᵢₒᵣ may have a constant value. By contrast, according to another embodiment, Tᵢₙₜₑᵣᵢₒᵣ may not be constant and, instead, may change over time depending on T_{ambient}. More specifically, in one scenario, Tᵢₙₜₑᵣᵢₒᵣ may be referred to as T_{interior,hot} (i.e., the temperature when the one or more passive temperature-control members are being warmed), which may occur when T_{ambient}(t)>T_{interior,hot} and T_{interior,cold} (i.e., the temperature when the one or more passive temperature-control members are being cooled). In another scenario, Tᵢₙₜₑᵣᵢₒᵣ may be referred to as T_{interior,cold}, which may occur when T_{ambient}(t)<T_{interior,hot} and T_{interior,cold}. In still another scenario, Tᵢₙₜₑᵣᵢₒᵣ may be the average of T_{interior,hot} and T_{interior,cold}, which may occur in all other cases.

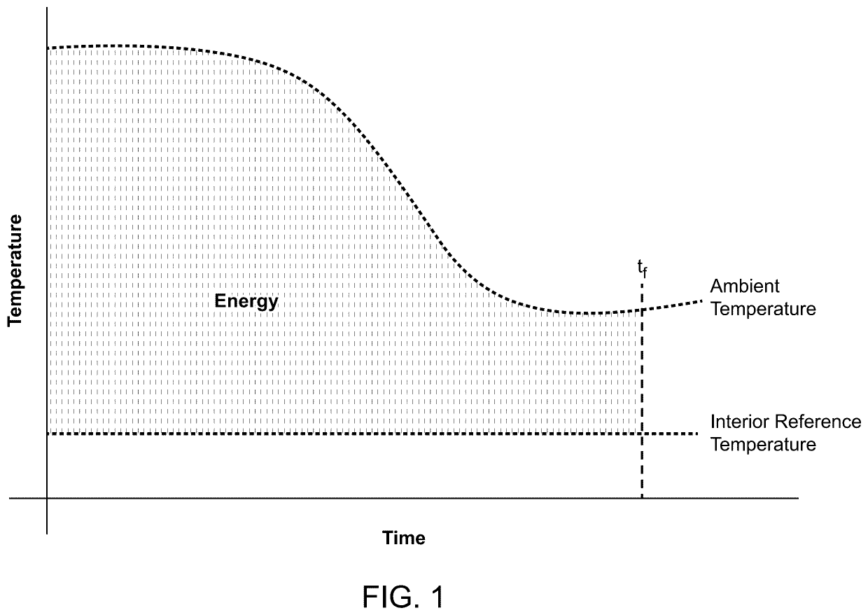

As can be seen, the energy absorbed from time 0 to t_{final} is proportional to the integral of the temperature difference over time. The integral calculates the area between two curves (i.e., the interior temperature curve and the ambient temperature curve), so this process can be visualized in FIG. 1. The calculated quantity is referred to as energy. It is not, in fact, the amount of heat energy actually entering the system, but it may be referred to as such since the calculated energy is proportional to the actual amount of heat energy entering the system. This value is also sometimes referred to as “area-under-the-curve (AUC) energy” after the method used to calculate it.

At this point, one could make another common assumption, namely, that the heat energy that is absorbed by the system up until failure is always the same. If this were true, one could take any ambient temperature profile and perform the energy calculation at regular time intervals until the failure energy is reached. This is sometimes referred to as the “energy limit” or the “capacitance” of the passive thermal shipping system. Once the energy limit has been reached, one can assume that the shipping system has failed.

The present technique, however, does not assume that the amount of heat energy that is absorbed by the system up until failure is always the same. Instead, the present technique assumes that the failure energy is dependent upon the ambient temperature. In other words, when exposed to extreme ambient temperatures, heat energy may enter the system so quickly that it may overwhelm the thermal protective measures of the system. In this case, it could take less total energy to cause failure. To operate using this assumption, data may be collected to determine the failure energy at a wide range of temperatures, such data sometimes referred to herein as “temperature sweep data” or “thermal capacitance data.” As the model iteratively calculates the energy with the progression of time, it is compared to the failure energy based on the ambient temperature. This allows one to determine if failure has occurred.

In a preferred embodiment, the present technique may include one additional refinement. Sometimes there is a lag between when the ambient temperature changes and when the temperature-sensitive payload responds. This can be accounted for by changing the temperature that is used to determine the failure energy. This new temperature, sometimes referred to herein as “effective temperature,” may change more slowly than the actual ambient temperature to account for the lag. To determine the effective temperature, a number of steps may be taken. One such step may involve calculating a rolling average of the ambient temperature. The rolling average may be calculated by averaging the ambient temperatures over a certain period of time preceding each data point. The use of such a rolling average may help to filter out or to smooth otherwise noisy data caused by rapid changes in temperature. There are several variations in how the rolling average is calculated. Some include additional weighting at different positions within the averaging period. Any variation which filters or otherwise smooths the time series may be used. For example, a weighted moving average could be applied to the ambient profile and then assigned a weight factor and added into the effective temperature. The weighted moving average is a rolling average where different weights are assigned to different positions within the period being averaged.

In addition to calculating a rolling average of ambient temperature, the present technique also may use the actual ambient temperature and a cumulative average ambient temperature. The aforementioned cumulative average ambient temperature may be the average ambient temperature up to a point in time. The rolling average of ambient temperature, the actual ambient temperature, and the cumulative average ambient temperature may be combined in a weighted average to yield an effective temperature (T_{effective}). Equation 3 below illustrates how effective temperature (T_{effective}) may be calculated using the rolling average of ambient temperature (T_{Rolling Average}), the cumulative average ambient temperature (T_{Cumulative Average}), and the actual ambient temperature (T_{Actual Ambient}), with A, B, and C being weight factors that determine which temperature the effective temperature matches most closely.

$${T}_{effective} = \frac{A * {T}_{Rollinq Averaqe} + B * {T}_{Cumulative Averaqe} + C * {T}_{Actual Ambient}}{A + B + C} \qquad ( 3 )$$

To summarize, the present technique may use an ambient temperature profile and may calculate the area-under-the-curve energy at each point in time along the ambient temperature profile. The present technique also may calculate an effective temperature profile as well. Using temperature sweep data, the present technique may determine the energy limit at each point in time as a function of the effective temperature, and at each point in time, the area-under-the-curve energy may be compared to the energy limit. The first time that the area-under-the-curve energy exceeds the energy limit, the present technique may declare a failure and return that information to a user. For the present technique to perform these calculations, it is preferably given the following information, which may be unique characteristics of each passive thermal shipping system and should be determined before the present technique may be deployed for use: temperature sweep data; rolling average period; rolling average weight factor; cumulative average weight factor; actual temperature weight factor; and interior reference temperature. Rolling average period, rolling average weight factor, cumulative average weight factor, actual temperature weight factor, and interior reference temperature may be collectively referred to herein as “system variables.”

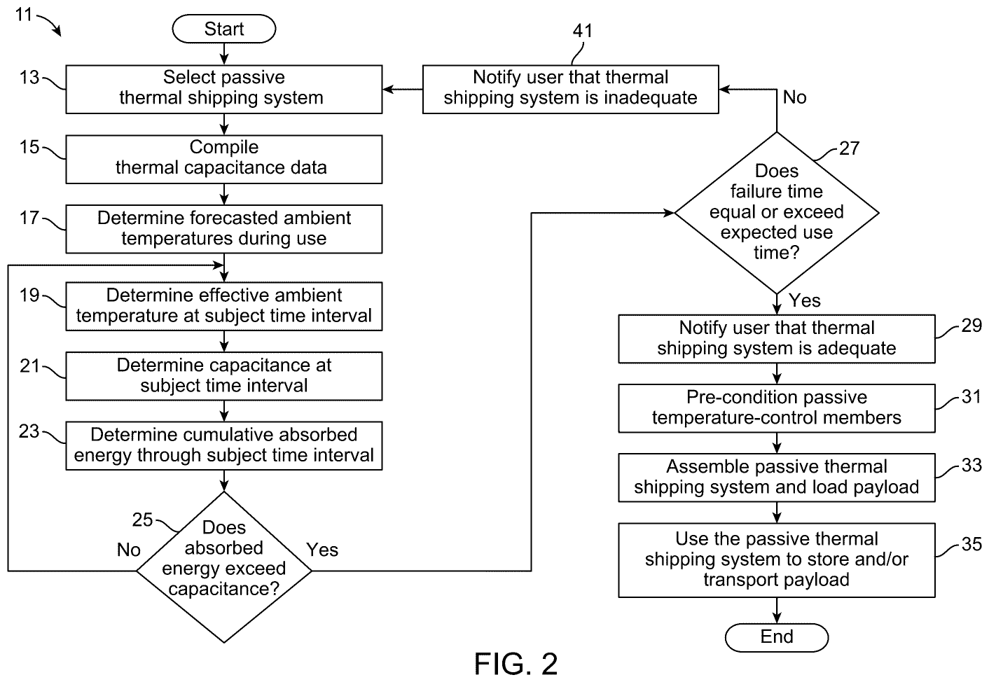

Referring now to FIG. 2, there is shown a flowchart depicting a first embodiment of a method according to the present invention for storing and/or transporting a payload of temperature-sensitive materials, the method being represented generally by reference numeral 11. Details of method 11 that are discussed elsewhere in this application or that are not critical to an understanding of the invention may be omitted from FIG. 2 and/or from the accompanying description herein or may be shown in FIG. 2 and/or described herein in a simplified manner.

Method 11 may comprise a step 13 of selecting a passive thermal shipping system for consideration in storing and/or transporting a payload of temperature-sensitive materials. The passive thermal shipping system may be a conventional passive thermal shipping system; alternatively, the passive thermal shipping system may be a novel passive thermal shipping system, such as, but not limited to, a passive thermal shipping system that is designed specifically for the task at hand. The passive thermal shipping system should have a payload capacity sufficient to hold the payload in question. Step 13 may involve selecting the passive thermal shipping system from a list of potential passive thermal shipping systems based on one or more factors, including, but not limited to, the following: the payload capacity of the passive thermal shipping system; the desired temperature range for the payload to be maintained (e.g., refrigerated (i.e., about +2° C. to about +8° C.), room temperature (i.e., about +15° C. to about +25° C.), frozen (i.e., about −25° C. to about −15° C.), etc.); and the ambient temperatures to which the passive thermal shipping system is expected to be exposed while in transit and/or during storage. The selection of the passive thermal shipping system according to step 13 may be performed with or without the aid of a compute device but is preferably performed with the aid of a compute device. For example, and without limitation, if step 13 is performed with the aid of a compute device, the selection of the thermal shipping system may be performed using a method and system of the type described in U.S. patent application Ser. No. 16/246,435, inventors Chasteen et al., filed Jan. 11, 2019, which issued Aug. 6, 2024, as U.S. Pat. No. 12,056,654 B1, the disclosure of which is incorporated herein by reference. A commercial embodiment of the aforementioned method and system is available from Cold Chain Technologies, LLC (Franklin, MA) using the CCT Route Pro™ non-downloadable software application app.

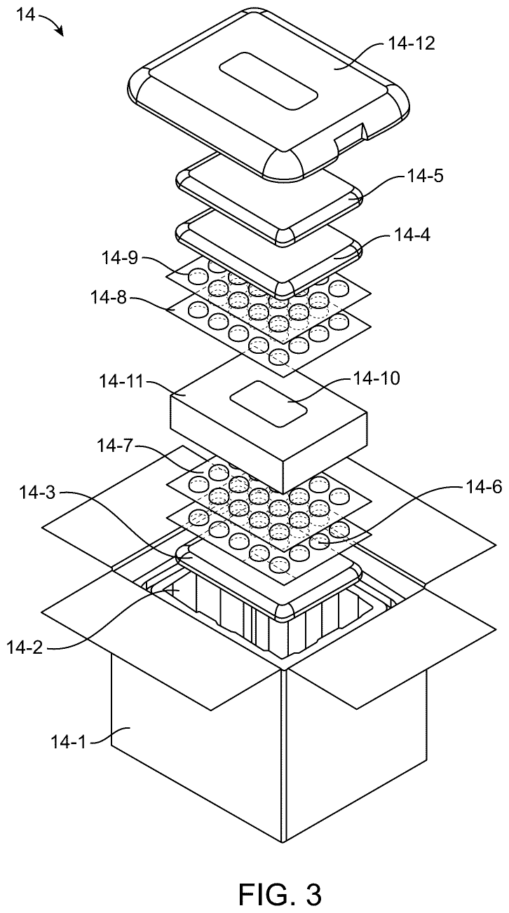

Referring now to FIG. 3, there is shown a partly exploded perspective view of an exemplary passive thermal shipping system of the type that may be selected in step 13, the passive thermal shipping system being represented generally by reference numeral 14. Details of passive thermal shipping system 14 that are discussed elsewhere in this application or that are not critical to an understanding of the invention may be omitted from FIG. 3 and/or from the accompanying description herein or may be shown in FIG. 3 and/or described herein in a simplified manner.

Passive thermal shipping system 14 may be designed to maintain a payload volume of about 2 L within a refrigerated temperature range (e.g., +2° C. to +8° C.) for an extended period of time where the payload is expected to be exposed to hot or summer-like ambient temperatures. More specifically, passive thermal shipping system 14 may comprise an outer box 14-1, which may be made of, for example, corrugated cardboard, an insulated base 14-2, which may be made of, for example, expanded polystyrene and which may be appropriately dimensioned to hold up to a 2 L payload, a plurality of phase-change elements 14-3, 14-4 and 14-5, which may be, for example, identical water-based gel packs preconditioned to a frozen/solid state at −5° C. to 0° C., a plurality of bubble wrap sheets 14-6, 14-7, 14-8, and 14-9, a temperature indicator 14-10, a payload box 14-11, which may be made of, for example, corrugated cardboard, and an insulated lid 14-12, which may mate with and be made of the same material as insulated base 14-2. (In some cases, payload box 14-11 may be omitted, with the payload not being contained within a separate payload box. Also, in some cases, temperature indicator 14-10 and/or one or more of bubble wrap sheets 14-6, 14-7, 14-8 and 14-9 may be omitted.)

In use, insulated base 14-2 may be placed inside of outer box 14-1, and phase-change element 14-3 may be placed within insulated base 14-2 on top of its inner bottom wall. Then, bubble wrap sheets 14-6 and 14-7 may be placed on top of phase-change element 14-3. Then, payload box 14-11 with payload (or the payload alone) may be centered within insulated base 14-2 and placed on top of bubble wrap sheets 14-6 and 14-7. Then, the temperature indicator 14-10 may be placed directly on top of payload box 14-11 (or directly on top of the payload). Then, bubble wrap sheets 14-8 and 14-9 may be placed on top of temperature indicator 14-10. Then, phase-change elements 14-4 and 14-5 may be placed on top of bubble wrap sheets 14-8 and 14-9. Then, additional bubble wrap may be used to fill all void spaces. Then, the insulated lid 14-12 may be placed on top of insulated base 14-2, and the outer box 14-1 may be closed and taped shut. It is to be understood that passive thermal shipping system 14 is merely illustrative and that changes to the size, shape, composition and construction thereto may be made.

Referring back now to FIG. 2, method 11 may further comprise a step 15 of compiling thermal capacitance data for the passive thermal shipping system that is selected in step 13. According to one embodiment, step 15 may first involve determining the failure time for the selected passive thermal shipping system at each of a plurality of temperatures spanning a broad range of potential ambient temperatures. Preferably, the failure time is determined at each of a plurality of temperatures that are spaced apart at regular temperature intervals (e.g., one degree temperature intervals) within the broad range of potential ambient temperatures. The determination of the failure time at each temperature interval within the broad range of ambient temperatures may be performed, and is preferably performed, virtually, using, for example, conventional thermal modeling software, such as SIMCENTER 3D software (Siemens AG, Munich, Germany). Alternatively, the determination of the failure time at each temperature interval within the broad range of ambient temperatures may be performed by actual physical testing, which, in some cases, may be impractical due to time constraints. Additionally, in some cases, a combination of actual physical testing and computer-aided thermal modeling may be desirable. Once the failure time at each temperature interval within the broad range of ambient temperatures has been ascertained, step 15 may then involve determining the capacitance (or area-under-the-curve energy) at each such temperature interval using Equation 4:

$$Thermal capacitance = ( {T}_{ambient} - {T}_{ref} ) * {t}_{failure} \qquad ( 4 )$$

wherein T_{ambient} represents the particular ambient temperature at issue, wherein Tef represents the desired temperature at which the payload is to be maintained (if the desired temperature is a range of temperatures, T_{ref} may the midpoint of the range), and wherein t_{failure} represents the failure time at the particular ambient temperature at issue. The aforementioned capacitance determinations are preferably performed using a compute device or the like. (Notwithstanding the sequence of steps described above, in practice, the determination of failure times is preferably conducted in advance of the point of use process described herein. For example, the failure times for the selected system may be imported from a library, and the capacitances may be calculated. Consequently, one may obtain a library of thermal capacitance data for a predefined variety of passive thermal shipping systems, and then one may select a particular passive thermal shipping system from the predefined variety of passive thermal shipping systems. Therefore, in certain cases, step 15 may be performed prior to step 13.)

According to one embodiment, T_{ref} may have a constant value. By contrast, according to another embodiment, T_{ref} may not be constant and, instead, may change over time depending on T_{ambient}. More specifically, in one scenario, T_{ref} may be referred to as T_{ref,hot} (i.e., the temperature when the one or more passive temperature-control members are being warmed), which may occur when T_{ambient}(t)>T_{ref,hot} and T_{ref,cold} (i.e., the temperature when the one or more passive temperature-control members are being cooled). In another scenario, Tᵣₑf may be referred to as T_{ref,cold}, which may occur when T_{ambient}(t)<T_{ref,hot} and T_{ref,cold}. In still another scenario, T_{ref} may be the average of T_{ref,hot} and T_{ref,cold}, which may occur in all other cases.

Method 11 may further comprise a step 17 of determining the forecasted ambient temperatures that the selected passive thermal shipping system is expected to be subjected to while being used for storage and/or transportation of the payload. Where the selected passive thermal shipping system is used to transport the payload from a first location to a second (i.e., different) location, step 17 may involve determining a route that the shipping system may use to travel from the first location to the second location and may also involve determining the expected ambient temperatures at regular time intervals (e.g., 10-minute, 30-minute, 60-minute, etc.) along the aforementioned route. The determination of the route and the determination of expected ambient temperatures at regular time intervals along said route may be performed, and is preferably performed, using some or all of the method and system disclosed in U.S. patent application Ser. No. 16/246,435, now U.S. Pat. No. 12,056,654 B1. For example, the determination of the route to be taken may be effected using a compute device that is in communication, for example, over the internet, with a corresponding compute device of a party, such as a courier, that provides transport/delivery services for others, typically for a fee, and that provides information regarding its transport/delivery routes. The determination of the forecasted ambient temperatures along the transport/delivery route may be effected using a compute device that is in communication, for example, over the internet, with a corresponding compute device of a party, such as a weather service, that makes available, either for a fee or at no charge, weather-related information to other parties.

Although step 17 is shown in method 11 as following step 15, step 17 may be performed prior to or concurrently with step 15. In fact, unless the type of passive thermal shipping system that is selected dictates that a certain transport/delivery route be used or precludes the use of certain transport/delivery routes, step 17 may be performed prior to or concurrently with step 13.

Method 11 may continue with a step 19 of determining the effective ambient temperature at a first time interval of the period during which the passive thermal shipping system is projected to be in use. According to one embodiment, the effective ambient temperature (T_{effective}) at any given time interval may be determined using Equation 5:

$${T}_{effective} = \frac{A * {T}_{Rolling Average} + B * {T}_{Cumulative Average} + C * {T}_{Actual Ambient}}{A + B + C} \qquad ( 5 )$$

wherein T_{Rolling Average} represents a rolling average of the ambient temperature, wherein T_{Cumulative Average} represents the average ambient temperature up to and including the subject time interval, wherein T_{Actual Ambient} represents the actual ambient temperature at the subject time interval, and wherein A, B, and C represent weight factors (which may be determined, at least in part, using computer simulations) that determine which of the three types of temperature values the effective temperature matches most closely. The rolling average, which may be calculated by averaging a certain period of time preceding each time interval, may be used to smooth out rapid changes in temperature. Step 19 may be performed partially or entirely using a compute device and is preferably performed entirely using a compute device.

Method 11 may continue with a step 21 of determining the capacitance at the first time interval. In one embodiment, step 21 may involve identifying, from the compilation of capacitance values obtained in step 15, the capacitance value corresponding to the temperature that is closest to the effective temperature determined in step 19. This value may be regarded as the energy limit for the selected passive thermal shipping system. Step 21 may be performed partially or entirely using a compute device and is preferably performed entirely using a compute device.

Method 11 may continue with a step 23 of determining the cumulative energy that is absorbed by the selected passive thermal shipping system up to and including the subject time interval. According to one embodiment, this energy may be calculated using Equation 6:

$$E ∼ {\int }_{0}^{{t}_{final}} Δ T ( t ) dt = {\int }_{0}^{{t}_{final}} {T}_{ambient} ( t ) - {T}_{ref} dt \qquad ( 6 )$$

wherein E is the cumulative absorbed energy up to and including the subject time interval, wherein t_{final} is the duration of time up to and including the subject time interval, wherein T_{ambient} is the forecasted ambient temperature at the subject time interval, and wherein T_{ref} is the midpoint of the desired temperature range for the payload (or is any value near the midpoint or within the temperature range). Step 23 may be performed partially or entirely using a compute device and is preferably performed entirely using a compute device.

Method 11 may continue with a step 25 of comparing the capacitance at the first time interval, as determined in step 21, to the cumulative absorbed energy up to and including the first time interval, as determined in step 23. Step 25 may be performed partially or entirely using a compute device and is preferably performed entirely using a compute device.

If the cumulative absorbed energy determined in step 23 exceeds the capacitance determined in step 21, the selected passive thermal shipping system is regarded as having failed within the first time interval. In the event of such failure, method 11 may continue with a step 27 of comparing the time to failure with the expected required duration of storage and/or transportation. Step 27 may be performed partially or entirely using a compute device and is preferably performed entirely using a compute device.

If the time to failure is at least as great as the expected required duration of storage and/or transportation (which is unlikely in the case of a first time interval), then the selected thermal shipping system is adequate for its intended purpose, and method 11 may continue with a step 29 of notifying a user that the selected passive thermal shipping system is adequate for its intended purpose. The notification of step 29 may involve, for example, one or more of a visual notification on a monitor of the compute device performing method 11 and/or on a monitor of a remote compute device; an auditory notification on a speaker of the compute device performing method 11 and/or on a speaker of a remote compute device; and an electronic message transmitted to a remote compute device.

Method 11 may then continue from step 29 to a step 31 of preconditioning the one or more passive temperature-control members of the passive thermal shipping system according to the packout instructions for the passive thermal shipping system, followed by a step 33 of assembling the passive thermal shipping system and loading the payload according to the aforementioned packout instructions, and then followed by a step 35 of using the passive thermal shipping system to store and/or to transport the payload.

On the other hand, if the time to failure is less than the expected required duration of storage and/or transportation, the selected passive thermal shipping system may be regarded as inadequate for its intended use. In this case, method 11 may continue with a step 41 of notifying a user that the selected passive thermal shipping system is inadequate for its intended purpose. The manner of notification of step 41 may be similar to that discussed above in connection with step 29. In addition, method 11 may continue with steps 13, 15, 17, 19, 21, 23 and 25 being repeated for a second (i.e., different) selected passive thermal shipping system. If the second selected passive thermal shipping system does not require that a change be made to the transport/delivery route, the same data obtained previously from step 17 may be used, and step 17 may be bypassed. On the other hand, if a change to the transport/delivery route is needed, step 17 should be performed for the new transport/delivery route.

If, in performing step 25, the capacitance of step 21 exceeds the cumulative absorbed energy of step 23, method 11 may continue with steps 19, 21, 23 and 25 being repeated for the next time interval. In this case, step 25 may involve comparing the capacitance at the second time interval, as determined in step 21, to the cumulative absorbed energy up to and including the second time interval, as determined in step 23. If the capacitance at the second time interval exceeds the cumulative absorbed energy up to and including the second time interval, method 11 may continue with steps 19, 21, 23 and 25 being repeated for the next time interval and so on. On the other hand, if the capacitance at the second time interval is less than the cumulative absorbed energy, method 11 continues with step 27. As can be appreciated, if desired, the foregoing process may be repeated until a suitable passive thermal shipping system has been determined for the particular transport/delivery route indicated. In such a case, the subject passive thermal shipping system may then follow steps 29, 31, 33 and 35.

As can be appreciated, several steps of method 11 may be completely automated. In fact, once a user has selected a passive thermal shipping system and indicated the origin/destination for the selected passive thermal shipping system, method 11 may provide an automated evaluation as to whether or not the selected passive thermal shipping system is adequate for transport. If a determination is made that the selected passive thermal shipping system is adequate, the user may pre-condition the temperature-control members, assemble the passive thermal shipping system with the payload, and transport the payload using the passive thermal shipping system.

In an alternative embodiment of method 11, some of the steps described above may be performed in a series of intermediate steps. For example, if the goal is to determine when enough energy has been absorbed that the system has reached a final temperature (i.e., T_{final}), a similar process can be used to determine whether the shipper has absorbed enough energy to reach a set of temperatures between an initial temperature (i.e., Tᵢₙᵢₜᵢₐₗ) and T_{final}. Typically, there are two final temperatures, namely, one hotter than Tᵢₙᵢₜᵢₐₗ (i.e., T_{final,hot}) and one colder than Tᵢₙᵢₜᵢₐₗ (i.e., T_{final,cold}). In this embodiment, one may assume that the shipper will pass through a series of temperatures up to T_{final}, i.e., T₁, T₂, T₃ . . . T_{final}. The initial temperature may be regarded as T₀. Thus, the full range of temperatures the system might pass through may be T_{final,cold} . . . T₋₂, T₋₁, Tᵢₙᵢₜᵢₐₗ, T₁, T₂ . . . T_{final,hot}. At any time (tᵢ), the interior temperature (Tᵢₙₜₑᵣᵢₒᵣ) is between two of these temperatures. The closest temperature greater than T_{interior,i} is T_{n,i}, and the closest temperature less than T_{interior,i} is T_{n-1,i}. One may assume that there is a capacitance corresponding to each temperature within this range. When the energy absorbed exceeds the capacitance corresponding to T_{n,i}, one may assume that T_{interior,i} has exceeded Tₙ. The time at which the system reaches Tₙ is t_{failure,n}. Each period from t_{failure,n-1} to t_{failure,n} may be referred to as a stage. At each stage, the reference temperature (T_{ref}) should be between Tₙ and Tₙ₋₁. To this end, one may use the average of Tₙ and Tₙ₋₁.

For example, a system might begin at 5° C. (Tᵢₙᵢₜᵢₐₗ), and the failure temperature might be 8° C. (T_{final}). We wish to know the time that the system reaches 8° C. (t_{failure,8° C.}). Normally, one would calculate the absorbed energy and compare it to the capacitance to determine t_{failure,8° C.}. However, the system must first pass through 6° C. (T₁) and 7° C. (T₂). At first, the reference temperature is between 5° C. and 6° C. Once the system absorbs enough energy, assume it has reached 6° C. This occurs at time t_{failure,6° C.}. After t_{failure,6° C.}, the system has advanced to the next stage, where it is between 6° C. to 7° C. At this time, Tᵣₑf should also fall within this range. One may continue this process until the system reaches T_{final}.

At each ambient temperature (T_{ambient}), there is a capacitance for each intermediate temperature Tₙ. It can be found using the below equation if the failure times are known. These may be found by conducting initial tests or simulations to determine the failure times at a plurality of temperatures spanning a range of potential ambient temperatures to which the first passive thermal shipping system may be subjected during a period of storage and/or transport. The results can be tabulated and referenced.

$$Capacitance ( {T}_{ambient} , {T}_{n} ) = {\sum }_{{T}_{1}}^{{T}_{n}} ( {T}_{ambient} - \frac{{T}_{i} - {T}_{i - 1}}{2} ) \times ( {t}_{failure , i} - {t}_{failure , i - 1} ) \qquad ( 7 )$$

$${T}_{0} = {T}_{initial}$$

$${t}_{failure , 0} = 0$$

When calculating the cumulative absorbed energy of a profile using this method, the same basic formula may be used.

$$E ∼ {\int }_{0}^{{t}_{final}} Δ T ( t ) dt = {\int }_{0}^{{t}_{final}} {T}_{ambient} ( t ) - {T}_{ref} dt \qquad ( 8 )$$

However, T_{ref} is no longer considered a constant. T_{ref} depends on the current stage and is somewhere between Tₙ and Tₙ₋₁. Again, one may use the average of those two values. The formula now reads as follows:

$$E ∼ {\int }_{0}^{{t}_{final}} Δ T ( t ) dt = {\int }_{0}^{{t}_{final}} {T}_{ambient} ( t ) - {T}_{ref} ( t ) dt \qquad ( 9 )$$

To determine T_{ref}, the cumulative absorbed energy may be calculated at regular time intervals. For each time, there is an upper temperature limit, Tₙ, and a lower temperature limit, Tₙ₋₁, and

$${T}_{ref} = \frac{{T}_{n} + {T}_{n - 1}}{2} \qquad ( 10 )$$

The cumulative absorbed energy may be compared to capacitances for the upper and lower temperature limits at each interval. If the cumulative absorbed energy exceeds Capacitance(T_{ambient},Tₙ), then the system may advance to the next stage, and Tₙ may become Tₙ₊₁ at the next interval where the absorbed energy is calculated. A system may also lose energy. If the absorbed energy drops below Capacitance(T_{ambient},Tₙ₋₁), the system may advance to the previous stage, and Tₙ may become Tₙ₋₁. This process may continue until Tₙ=T_{final,hot} or Tₙ₋₁=T_{final,cold}. When the absorbed energy exceeds Capacitance(T_{ambient},T_{final,hot}), the system is assumed to have failed. When the absorbed energy is less than Capacitance(T_{ambient},T_{final,cold}), the system is also assumed to have failed.

For the first time step, T_{ref} may be assumed to be equal to Tᵢₙᵢₜᵢₐₗ. This is because the system is not yet between any two temperatures Tₙ and Tₙ₋₁. If the system absorbs energy during the first time step, then T_{ref} will subsequently be (T₁+Tᵢₙᵢₜᵢₐₗ)/2. If the system loses energy during the first time step, then T_{ref} will subsequently be (T₋₁+Tᵢₙᵢₜᵢₐₗ)/2. If the system does not gain or lose energy, which happens when T_{ambient}=T_{ref}, then the process can be repeated, or the system can arbitrarily be treated as if it gained a small amount of energy, or one of the other two options previously identified can be selected arbitrarily.

As in the previous method, T_{ambient} may be replaced with an effective temperature T_{effective} when calculating the capacitance. This is to account for lag between the time when the ambient temperature changes and when the system responds. The formula for T_{effective} is the same as before.

The steps of the process for calculating energy according to this embodiment are listed below. One may assume that time steps occur in regular intervals of Δt. At each time step, the change in cumulative absorbed energy (E) is calculated; this is ΔE.

| Time Step | Energy Calculatᵢon Steps | | |
|---|---|---|---|
| 0 | 1. | T_{ref}(t₀) = Tᵢₙᵢₜᵢₐₗ | |
| | 2. | ΔΕ (t₀) = (T_{ambient}(t₀) − T_{ref}) Δt | |
| 1 | 1. | E(t₁) = ΔE (t₀) | |
| | 2. | If ΔE (t₀) > 0: Tₙ = T₁ \| If ΔE (t₀) < 0: Tₙ = T₀ | |
| | 3. | ${T}_{ref} ( {t}_{1} ) = \frac{( {T}_{n} + {T}_{n - 1} )}{2}$ | (Equation 4) |
| | 4. | ΔΕ(t₁) = (T_{ambient}(t₁) − T_{ref}(t₁)) Δt | |
| 2 | 1. | E(t₂) = E(t₁) + ΔE (t₁) | |
| | 2. | Capacitanceᵤₚₚₑᵣ = Capacitance(T_{effective,2}, T_{n,1}), | |
| | | Capacitance_{lower} = Capacitance(T_{effective,2}, T_{n-1,1}) | |
| | 3. | If E(t₂) > Capacitanceᵤₚₚₑᵣ: T_{n,2} = T_{n+1,1} | |
| | | If E(t₂) < Capacitance_{lower}: T_{n,2} = T_{n-1,1} | |
| | | If Capacitanceᵤₚₚₑᵣ > E(t₂) > Capacitance_{lower}: T_{n,2} = T_{n,1} | |
| | 4. | ${T}_{ref} ( {t}_{2} ) = \frac{{T}_{n , 2} + {T}_{n - 1 , 2}}{2}$ | (Equation 4) |
| | 5. | ΔΕ(t₂) = (T_{ambient}(t₂) − T_{ref}(t₂))Δt | |
| i | 1. | E(tᵢ) = E(tᵢ − 1) + ΔE (tᵢ − 1) | |
| | 2. | Capacitanceᵤₚₚₑᵣ = Capacitance(T_{effective,i}, T_{n,i-1}), | |
| | | Capacitance_{lower} = Capacitance (T_{effective,i}, T_{n-1,i-1}) | |
| | 3. | If E(tᵢ) > Capacitanceᵤₚₚₑᵣ: T_{n,i} = T_{n+1,i-1} | |
| | | If E(tᵢ) < Capacitance_{lower}: T_{n,i} = T_{n-1,i-1} | |
| | | If Capacitanceᵤₚₚₑᵣ > E(tᵢ) > Capacitance_{lower}: T_{n,i} = T_{n,i-1} | |
| | 4. | ${T}_{ref} ( {t}_{i} ) = \frac{{T}_{n , i} + {T}_{n - 1 , i}}{2}$ | (Equation 4) |

| | |
|---|---|
| 5. | ΔΕ(tᵢ) = (T_{ambient}(tᵢ) − T_{ref}(tᵢ)) Δt |

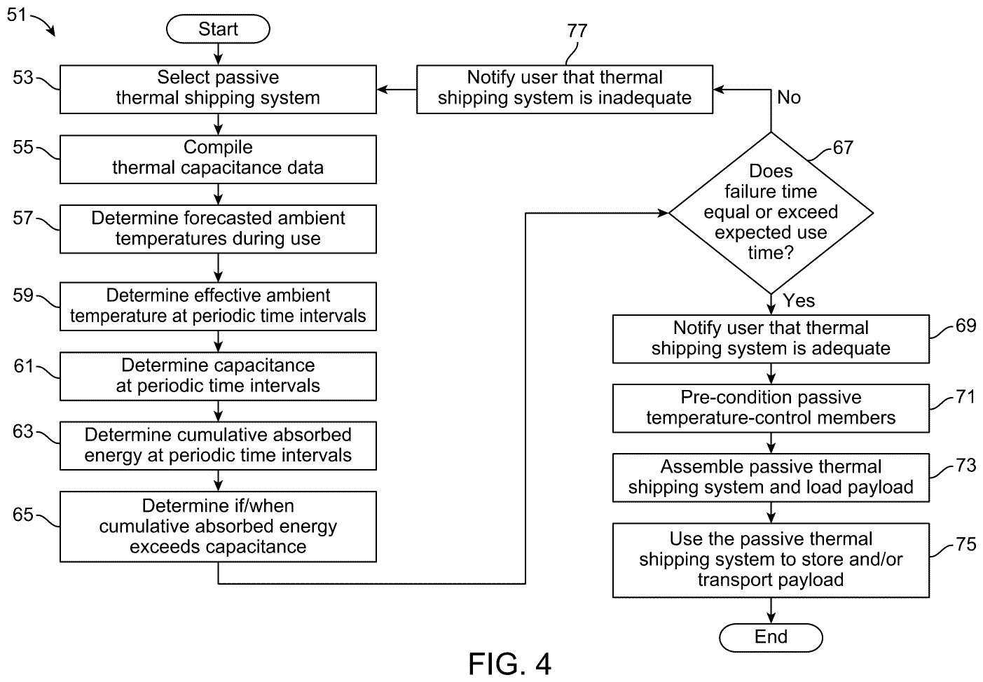

Referring now to FIG. 4, there is shown a flowchart depicting a second embodiment of a method according to the present invention for storing and/or transporting a payload of temperature-sensitive materials, the method being represented generally by reference numeral 51. Details of method 51 that are discussed elsewhere in this application or that are not critical to an understanding of the invention may be omitted from FIG. 4 and/or from the accompanying description herein or may be shown in FIG. 4 and/or described herein in a simplified manner.

Method 51 may be similar in many respects to method 11. A principal difference between the two methods may be that, whereas method 11 may comprise determining the capacitance and the cumulative energy absorbed at a first time interval, comparing these two values, and then, if the capacitance exceeds the cumulative energy at the time interval tested, repeating the foregoing steps for a successive time interval within the expected duration of use, method 51 may comprise determining the capacitance and the cumulative energy absorbed at a plurality of time intervals spaced throughout the entire expected duration of use and then comparing the results to determine if/when the cumulative energy absorbed first exceeded the capacitance.

Accordingly, method 51 may begin with a step 53 of selecting a passive thermal shipping system for consideration in storing and/or transporting a payload of temperature-sensitive materials. Method 51 may then continue with a step 55 of compiling thermal capacitance data for the passive thermal shipping system that is selected in step 53 and with a step 57 of determining the forecasted ambient temperatures that the selected passive thermal shipping system is expected to be subjected to while being used for storage and/or transportation of the payload. Steps 53, 55, and 57 may be similar or identical to steps 13, 15, and 17, respectively, of method 11.

Although step 57 is shown in method 51 as following step 55, step 57 may be performed prior to or concurrently with step 55. In fact, unless the type of passive thermal shipping system that is selected dictates that a certain transport/delivery route be used or precludes the use of certain transport/delivery routes, step 57 may be performed prior to or concurrently with step 53.

Method 51 may continue with a step 59 of determining the effective ambient temperature at a plurality of regular time intervals spaced throughout the entire period during which the passive thermal shipping system is projected to be in use. The effective ambient temperatures may be determined in a manner similar or identical to that discussed above in connection with step 19.

Method 51 may continue with a step 61 of determining the capacitance at each of the regular time intervals for which the effective ambient temperature has been determined in step 59. The manner in which such capacitance values are determined in step 61 may be similar or identical to that described in step 21 of method 11.

Method 51 may continue with a step 63 of determining the cumulative energy that is absorbed by the selected passive thermal shipping system at each of the foregoing regular time intervals. The manner in which such cumulative absorbed energy values are determined in step 63 may be similar or identical to that described in step 23 of method 11.

Method 51 may continue with a step 65 of comparing the capacitance values obtained in step 61 with the cumulative absorbed energy values obtained in step 63 to determine if/when the cumulative absorbed energy exceeds the capacitance. Step 65 may be performed by graphing the capacitance values and the cumulative absorbed energy values as a function of time and determining if/when the two profiles intersect. The first point of intersection, if any, represents the failure time for the selected passive thermal shipping system. Step 65 may be performed partially or entirely using a compute device and is preferably performed entirely using a compute device.

Method 51 may continue with a step 67 of determining whether the failure time, if any, is at least as great as the expected duration of use. Step 65 may be used to determine the failure time. Where the payload is being transported over a transport/delivery route, the expected duration of use may be the duration of the transport/delivery route. Step 67 may be performed partially or entirely using a compute device and is preferably performed entirely using a compute device.

If, in step 67, the failure time is at least as great as the expected duration of use, then the selected passive thermal shipping system may be regarded as adequate for its intended purpose, and method 51 may continue with a step 69 of notifying a user that the selected passive thermal shipping system is adequate for its intended purpose. Step 69 may be similar or identical to step 29 of method 11.

Method 51 may further comprise, after step 69, a step 71 of preconditioning the one or more passive temperature-control members of the passive thermal shipping system according to the packout instructions for the passive thermal shipping system, a step 73 of assembling the passive thermal shipping system and loading the payload according to the aforementioned packout instructions, and a step 75 of using the passive thermal shipping system to store and/or to transport the payload.

On the other hand, if the failure time is less than the expected duration of use, the selected passive thermal shipping system may be regarded as inadequate for its intended use. In this case, method 51 may continue with a step 77 of notifying a user that the selected passive thermal shipping system is inadequate for its intended purpose. The manner of notification of step 77 may be similar to that discussed above in connection with step 69. In addition, method 51 may continue with steps 53, 55, 57, 59, 61, 63 and 65 being repeated for a second (i.e., different) selected passive thermal shipping system. If the second selected passive thermal shipping system does not require that a change be made to the transport/delivery route, the same data obtained previously from step 57 may be used, and step 57 may be bypassed. On the other hand, if a change to the transport/delivery route is needed, step 57 should be performed for the new transport/delivery route.

It is to be understood that, although methods 11 and 51 are described above as concluding with the shipment of a payload with a selected passive thermal shipping system, the methods described herein may also be adapted for use while a payload is in transit with and/or in storage within a passive thermal shipping system. For example, while the shipping system is in use, if the failure time is determined to exceed the expected use time, an operator may intervene. Such an intervention may take the form of, for example, rerouting the payload, transferring the payload to a new shipping system, or sending an additional or replacement package. By contrast, if the failure time does not exceed the expected use time, the operator would take no action.

It is also to be understood that the evaluative portions of the methods described herein may also be used after a shipment has completed. For example, a quality assurance team could review whether the failure time exceeded the actual use time and decide whether to release the payload for use or to reject the payload.

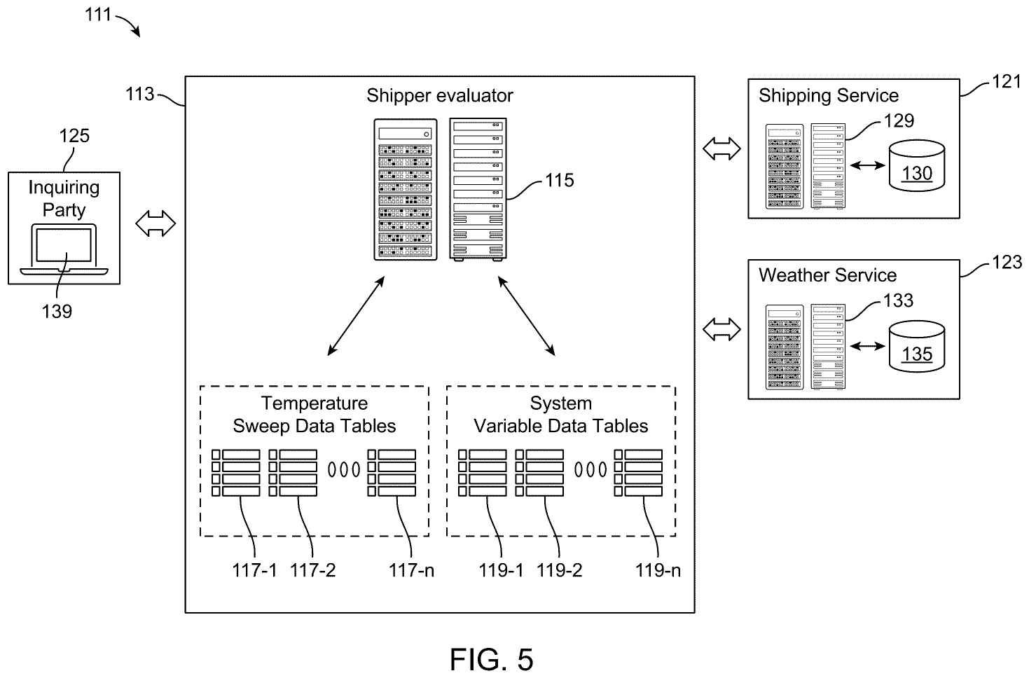

Referring now to FIG. 5, there is shown simplified schematic representation of one embodiment of a system for use in performing the method of FIG. 2, the system being constructed according to the present invention and being represented generally by reference numeral 111. Details of system 111 that are discussed elsewhere in this application or that are not critical to an understanding of the invention may be omitted from FIG. 5 and/or from the accompanying description herein or may be shown in FIG. 5 and/or described herein in a simplified manner.

System 111 may represent the basic network architecture of a thermal shipper evaluation and reporting system, the thermal shipper evaluation and reporting system being uniquely configured (i) to predict whether or not a subject passive thermal shipping system is properly configured to maintain a payload within a desired temperature range for the duration of an intended transport/delivery route and (ii) to report the results of said evaluation to an inquiring party.

System 111 may comprise a shipper evaluator 113. In the present embodiment, shipper evaluator 113 may comprise a central controller 115. Central controller 115 may have access to one or more sets of temperature sweep data tables 117-1 through 117-n, said temperature sweep data tables 117-1 through 117-n containing temperature sweep data. Temperature sweep data tables 117-1 through 117-n may be imported into or uploaded to central controller 115 from an external source or may be created by central controller 115 running an appropriate thermal modeling algorithm, such as SIMCENTER 3D software (Siemens AG, Munich, Germany). (The temperature sweep data tables 117-1 through 117-n would preferably be generated in advance and uploaded to a library which central controller 115 would access.) As discussed herein, central controller 115 may utilize one or more of temperature sweep data tables 117-1 through 117-n to predict whether a given passive thermal shipping system is likely to experience a failure condition during an intended transport/delivery route.

Central controller 115 may have access to one or more sets of system variable data tables 119-1 through 119-n, said system variable data tables 119-1 through 119-n containing system variable data, such as rolling average period, effective ambient temperature weight factors, and one or more reference temperatures. System variable data tables 119-1 through 119-n may be imported into or uploaded to central controller 115 from an external source or may be created by central controller 115 running an appropriate thermal modeling algorithm, such as SIMCENTER 3D software (Siemens AG, Munich, Germany). (The system variable data tables 119-1 through 119-n would preferably be generated in advance and uploaded to a library which central controller 115 would access.) As discussed herein, central controller 115 may utilize one or more of system variable data tables 119-1 through 119-n to predict whether a given passive thermal shipping system is likely to experience a failure condition during an intended transport/delivery route.

Shipper evaluator 113 may be in electronic communication with at least one shipping service 121, at least one weather service 123, and at least one inquiring party 125. Alternatively, shipper evaluator 113 may be in communication with a data logger placed in or on the shipment that relays time, temperature, and/or GPS data through cellular or satellite networks.

Shipping service 121 may be an entity of the type that provides transport/delivery services for others, typically for a fee, and that additionally provides information regarding its transport/delivery routes. Shipping service 121 may be linked with central controller 115 using a compute device 129. Compute device 129 may be any type of compute device that is adapted to interface with central controller 115 (e.g., through a designated web page or mobile application) to permit access to the aforementioned transport/delivery routes, which may be stored in a local or remote database 130 associated with compute device 129. Solely for purposes of example, compute device 129 is represented herein as a server; however, it is to be understood that compute device 129 could comprise another type of device or combinations of devices. Communication between compute device 129 and central controller 115 may be continuous but need not be continuous and, instead, may be intermittent, periodic, or on an as-needed basis.

In another embodiment, shipping service 121 could be eliminated, and the transport/delivery routes stored on compute device 129 could instead be stored on a data storage device associated with central controller 115. However, one advantage to the embodiment shown in FIG. 5 is that alterations or updates to the transport/delivery routes may be communicated to and/or retrieved by central controller 115. This reduces the possibility that shipper evaluator 113 may base a decision on outdated information.

Weather service 123 may be an entity of the type that makes available, either for a fee or at no charge, weather-related information to other parties. Such information may include, for example, historical, current and/or forecasted temperatures at various locations. Solely by way of example, such locations may include the location associated with each zip code or postal code throughout the world, throughout the United States, or in some subset thereof. Weather service 123 may include a compute device 133, on which the aforementioned weather-related information is accessible. Compute device 133 may be any type of compute device that is adapted to interface with central controller 115 (e.g., through a designated web page or mobile application) to permit access to the aforementioned weather-related data, which may be stored in a local or remote database 135 associated with compute device 133. Solely for purposes of example, compute devices 133 is represented herein as a server on which the above-described temperature-related data is stored; however, it is to be understood that compute device 133 could comprise another type of device or combinations of devices. Communication between compute device 133 and central controller 115 may be continuous but need not be continuous and, instead, may be intermittent, periodic, or on an as-needed basis.

Inquiring party 125 may be an entity that is desirous of ascertaining whether a passive thermal shipping system is properly configured to maintain a payload within a desired temperature range for the duration of an intended transport/delivery route. More specifically, inquiring party 125 may be an entity that uses or is contemplating using thermal shipping systems to transport one or more types of temperature-sensitive materials including, but not limited to, pharmaceuticals, biological materials, foods, beverages, and the like. As one non-limiting example, inquiring party 125 may be a pharmaceutical company that uses thermal shipping systems to transport pharmaceuticals and/or other temperature-sensitive materials to hospitals, clinics, medical practices, research facilities, and the like. As another non-limiting example, inquiring party 125 may be a food and/or beverage manufacturer that uses thermal shipping systems to deliver foods, beverages and/or other temperature-sensitive materials to food retailers, restaurants, residences, and the like. As yet another non-limiting example, inquiring party 125 may be a research institution that uses thermal shipping systems to deliver biological materials and/or other temperature-sensitive materials to other research institutions, to medical professionals, or the like.

Also, it should be understood that, although inquiring party 125 is discussed above as referring to an entity from which a payload is sent, inquiring party 125 could also refer to an entity to which a payload is sent (for example, where such a party orders a payload from a vendor). Alternatively, inquiring party 125 could refer to an entity that manufactures and/or sells one or more types of passive thermal shipping systems. It should also be understood inquiring party 125 may include any combination, permutation, or variation of the aforementioned groups.

As noted above, inquiring party 125 may be in electronic communication with shipper evaluator 113 using a compute device 139. Such communication may be continuous but need not be continuous and, instead, may be intermittent, periodic, or on an as-needed basis. Compute device 139 may be any type of compute device that is adapted to interface with central controller 115 (e.g., through a designated web page or mobile application) including, but not limited to, a desktop computer, a smartphone, a tablet computer, a kiosk-type compute workstation, or other device known in the art.

For simplicity purposes only, system 111 is depicted with a single shipping service 121, a single weather service 123, and a single inquiring party 125. However, it is to be understood that system 111 is readily scalable, with additional shipping services, weather services and/or inquiring parties capable of integration therein, as needed.

In use, according to one embodiment, an inquiring party 125 may use compute device 139 to request that shipper evaluator 113 make a prediction about whether a passive thermal shipping system at issue is capable of maintaining a payload within a desired temperature range during transport/delivery. Shipper evaluator 113 may then obtain information from shipping service 121 about the expected transport/delivery route and corresponding information from weather service 123 about the anticipated temperatures over said transport/delivery route. Shipper evaluator 113 may then make a prediction using the principles discussed above and then may communicate its prediction to inquiring party 125.

It is to be understood that, although system 111 is described above as being used in performing method 11, system 111 could also be used in performing method 51.

The following examples are given for illustrative purposes only and are not meant to be a limitation on the invention described herein or on the claims appended hereto.

### Example 1: Collection of Data to Characterize System Performance

An exemplary passive thermal shipping system was used. This system, which is designed to maintain a payload at temperatures between 1.95° C. and 8.04° C. (i.e., approximately 2° C. and 8° C.), includes an insulated container made of expanded polystyrene and passive temperature-control members providing six-sided coverage of the payload, each of the passive temperature-control members having a phase-change temperature of 5° C.

The first step is a one-time setup that characterizes the system. The goal of this step is to produce the temperature sweep data. First, the performance of the passive thermal shipping system was tested against known conditions, and data describing the performance was gathered. Using SIMCENTER 3D software (Siemens AG, Munich, Germany), a three-dimensional (3D) model was created that matched the test, and it was assumed that the 3D model was a good predictor of the performance of the shipping system. The purpose of the present method is to reproduce the results of the 3D model in less time. The 3D model typically took around 10 minutes to produce results whereas the present method required fractions of a second. The process described below could be done using physical test data, in which case the present method would predict the results of a physical test. This is prohibitively expensive. More realistically, a mix of physical test data and 3D simulation data might be employed.

Once a 3D model was obtained, system performance was determined at a wide range of temperatures. This was done by performing a series of 3D simulations with constant ambient temperatures at regular temperature intervals. Failure is the time at which the payload is no longer between 1.95° C. and 8.04° C. Failures were classified as cold failures if the payload temperature dropped below 1.95° C. and as hot failures if the payload temperature exceeded 8.04° C. The results of each simulation were checked to determine the failure time. In this example, performance at temperatures from −20° C. to 50° C. at one-degree intervals was simulated. TABLE I below shows the results of the 3D simulations. (Results were omitted at temperatures where there was no failure. Results were produced for the failure criteria temperatures (1.95° C. and 8.04° C.) by linearly extrapolating from the two closest points.) This data is referred to as the temperature sweep data. Temperature sweep data is one of the defining features of a system that is used in the present method. Each passive thermal shipping system has its own unique temperature sweep data.

TABLE I

| Cold Failures | | Hot Failures | |
|---|---|---|---|
| Simulation | | Simulation | |
| Ambient | Failure | Ambient | Failure |
| Temperature (° C.) | Time (hours) | Temperature (° C.) | Time (hours) |
| −20 | 1 | 8.04 | 407.8 |
| −19 | 1 | 10 | 300 |
| −18 | 1.5 | 11 | 245 |
| −17 | 1.5 | 12 | 207 |
| −16 | 1.5 | 13 | 179 |
| −15 | 1.5 | 14 | 157 |
| −14 | 1.5 | 15 | 139.5 |
| −13 | 1.5 | 16 | 125 |
| −12 | 2 | 17 | 113 |
| −11 | 2 | 18 | 103.5 |
| −10 | 2 | 19 | 95 |
| −9 | 2 | 20 | 87.5 |
| −8 | 2 | 21 | 81.5 |
| −7 | 2.5 | 22 | 76 |
| −6 | 2.5 | 24 | 66.5 |
| −5 | 3 | 25 | 63 |
| −4 | 3.5 | 26 | 59.5 |
| −3 | 4 | 27 | 56.5 |
| −2 | 4.5 | 28 | 53.5 |
| −1 | 6 | 30 | 49 |
| 0 | 8 | 31 | 46.5 |
| 1 | 13 | 32 | 44.5 |
| 1.95 | 17.75 | 33 | 43 |
| | | 34 | 41 |
| | | 35 | 39.5 |
| | | 36 | 38 |
| | | 37 | 37 |
| | | 38 | 35.5 |
| | | 39 | 34.5 |
| | | 40 | 33 |

### Example 2: Use Temperature Sweep Data to Determine Failure Energy as a Function of Temperature

The true area of interest here is not failure time as a function of temperature, but area-under-the-curve failure energy as a function of temperature. To find this information, Equation 7 below may be used. When there is a constant ambient temperature:

$$A U C Energy = ( {T}_{ambient} - {T}_{ref} ) * {t}_{failure} \qquad ( 11 )$$

wherein AUC Energy represents the area-under-the-curve energy, wherein T_{ambient} represents the ambient temperature, T_{ref} represents the midpoint of the temperature range at which the payload is supposed to be maintained, and t_{failure} represents the failure time.

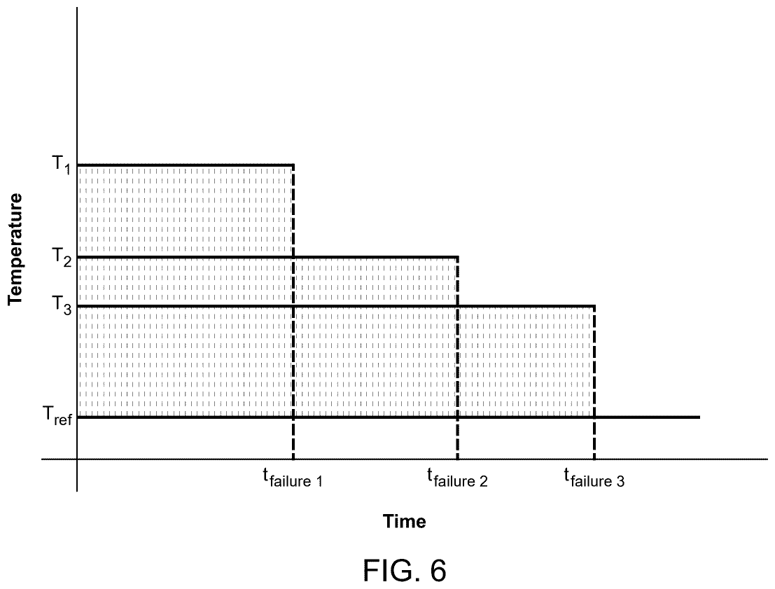

FIG. 6 is a visual representation of the process taking place in Equation 4 above. This process is applied to each of the temperatures that were simulated. A value must be assumed for the reference temperature (T_{ref}). Since this passive thermal shipping system is designed to stay between 1.95° C. and 8.04° C. prior to failure, T_{ref} may be assumed to be at the midpoint of that range, namely, 5° C. The process of converting temperature sweep data into failure energy vs. ambient temperature is the next step of the present method. The results of this process are shown below in TABLE II, which lists the failure energies at various temperatures assuming a 5° C. reference.

TABLE II

| | |
|---|---|
| Cold Failures | Hot Failures |

| Simulation | | Simulation | |
|---|---|---|---|
| Ambient | Energy at | Ambient | Energy at |
| Temperature | Failure | Temperature | Failure |
| (° C.) | (degC.*hr) | (° C.) | (degC.*hr) |
| −20 | −25 | 8.04 | 1370.797 |
| −19 | −24 | 10 | 1500 |
| −18 | −34.5 | 11 | 1470 |
| −17 | −33 | 12 | 1449 |
| −16 | −31.5 | 13 | 1432 |
| −15 | −30 | 14 | 1413 |
| −14 | −28.5 | 15 | 1395 |
| −13 | −27 | 16 | 1375 |
| −12 | −34 | 17 | 1356 |
| −11 | −32 | 18 | 1345.5 |
| −10 | −30 | 19 | 1330 |
| −9 | −28 | 20 | 1312.5 |
| −8 | −26 | 21 | 1304 |
| −7 | −30 | 22 | 1292 |
| −6 | −27.5 | 24 | 1263.5 |
| −5 | −30 | 25 | 1260 |
| −4 | −31.5 | 26 | 1249.5 |
| −3 | −32 | 27 | 1243 |
| −2 | −31.5 | 28 | 1230.5 |
| −1 | −36 | 30 | 1225 |
| 0 | −40 | 31 | 1209 |
| 1 | −52 | 32 | 1201.5 |
| 1.95 | −143.541 | 33 | 1204 |
| | | 34 | 1189 |
| | | 35 | 1185 |
| | | 36 | 1178 |
| | | 37 | 1184 |
| | | 38 | 1171.5 |
| | | 39 | 1173 |
| | | 40 | 1155 |

The following characteristic variables for the shipping system must be determined: rolling average period; rolling average weight factor; cumulative average weight factor; actual temperature weight factor; and reference temperature. TABLE III below provides certain initial assumptions for these values.

TABLE III

| | | | Rolling | Cumulative | Actual |
|---|---|---|---|---|---|
| | | Rolling | Average | Average | Temperature |
| | Reference | Average | Weight | Weight | Weight |
| Variable | Temperature | Period | Factor | Factor | Factor |
| Assumed | 5° C. | 10 | 0.4 | 0.3 | 0.3 |
| Value | | hours | | | |

### Example 3: Profile Transformation Using Rolling Average Period and Weight Factors

An exemplary ambient temperature profile was selected to demonstrate the ability of the present method to predict duration of thermal protection. The exemplary ambient temperature profile needed to be transformed into an effective temperature profile, which is a combination of the profile itself, the cumulative average of the profile, and the rolling average of the profile. In the present case, the rolling average was configured to be the average of the previous 10 hours of data. The cumulative average was configured to be the average of the entire profile up to a point in time. These values, together with the actual temperature, were used in Equation 8 below to calculate the following weighted average, also referred to herein as the effective temperature (T_{effective}):

$${T}_{effective} = 0.4 * Rolling Avg + 0.3 * Cumulative Avg + 0.3 * 0.3 * Actual Temp \qquad ( 12 )$$

The effective temperature changes more slowly than the actual profile and less slowly than the cumulative average. It is sometimes faster and sometimes slower than the rolling average. By adjusting the weight factors, one can reflect how quickly the subject passive thermal shipping system reacts to the ambient temperature.

### Example 4: Calculate Energy Limits at Each Time Using the Effective Temperature Profile

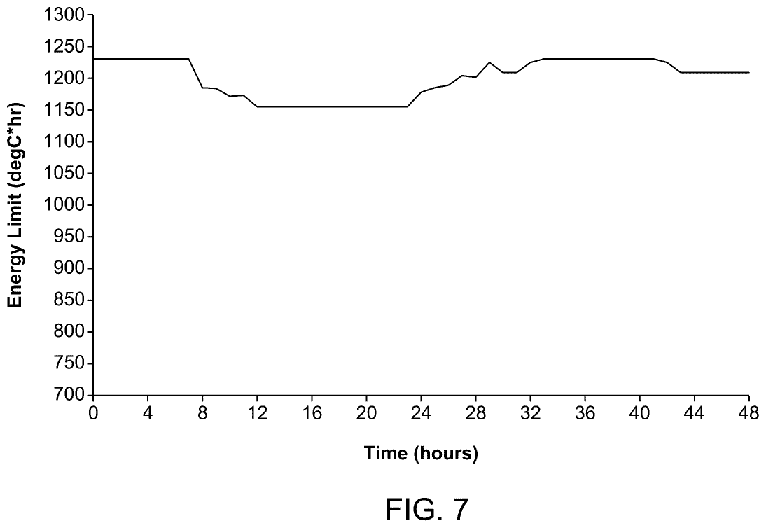

The failure energy limit may be determined at each time in the profile. As noted above, failure energy is a function of the ambient temperature. TABLE II provides the failure energies at each temperature. One can go through the profile and plug in the failure energy that most closely matches the temperature at each time. For example, for the first eight hours of the effective profile, the temperature is 28.8 degrees. The closest matching temperature is 28° C., and the corresponding failure energy is 1230.5 degC*hr. This information may be graphed, as shown in FIG. 7.

### Example 5: Calculate Energy Absorbed by the System for the Sample Profile

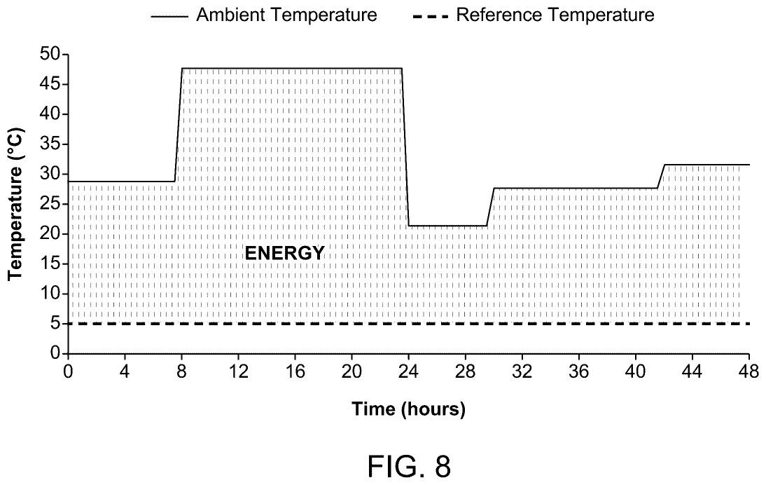

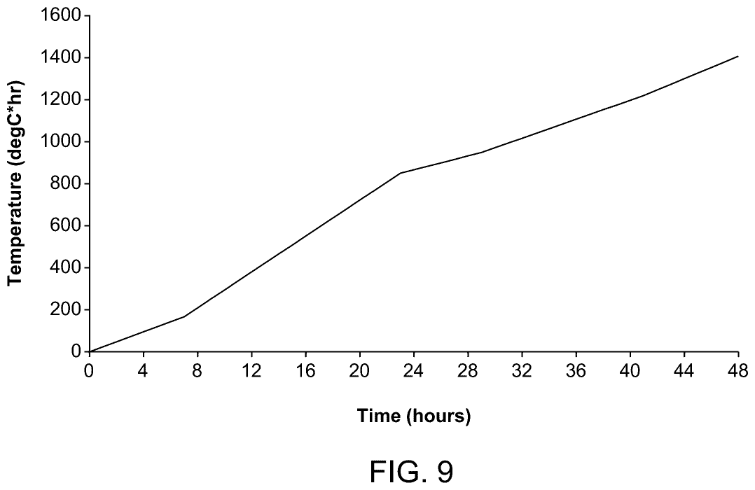

The amount of energy the system has absorbed along the profile may be calculated. Since this is a function of the profile, it may be referred to as profile energy. The energy is represented by the shaded area in FIG. 8. The energy at each time is the sum of all the area up to that time. FIG. 8 is a graphical representation of the process embodied in Equation 3. FIG. 9 shows a graph of profile energy vs. time that is made using the aforementioned equation.

### Example 6: Compare Profile Energy and Energy Limits

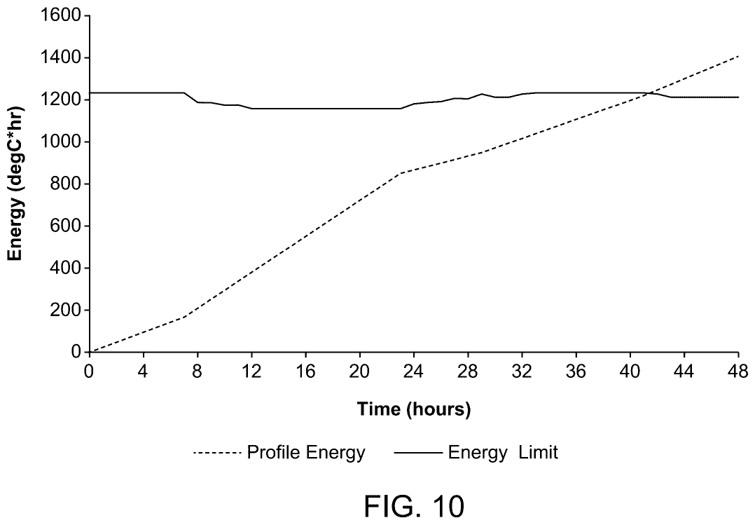

The final step is to compare the energy limit to the profile energy. FIG. 10 shows the increasing profile energy compared to the energy limit. As can be seen, the profile energy exceeds the energy limit around 42 hours. Therefore, the subject passive thermal shipping system would be predicted to maintain its payload at the required temperature for 42 hours. It may be worth noting that a 3D simulation, obtained using SIMCENTER 3D software (Siemens AG, Munich, Germany), also predicted 42 hours of duration.

Additional advantages, features, observations, comments and/or aspects of the present invention that may be applicable to one or more embodiments disclosed herein may include the following:
Certain assumptions were made to obtain the characteristic variables set forth in Table III. In the above examples, these characteristic variables led to a prediction that was consistent with the prediction of a 3D simulation. These characteristic variables may be tested against more than one temperature profile to see if they give similarly good results. If the technique consistently produces similar predictions to the 3D simulation, one can assume that the set of characteristic variables is a good set. Even though the variables identified above produced an excellent prediction for the sample temperature profile used, these variables did not give satisfactorily accurate results for many other temperature profiles that were tested. As a result, different sets of characteristic variable were tested, and TABLE IV below shows a set of characteristic variables for the subject shipping system that works well for a number of different temperature profiles.

TABLE IV

| | | | Rolling | Cumulative | Actual |
|---|---|---|---|---|---|
| | | Rolling | Average | Average | Temperature |
| | Reference | Average | Weight | Weight | Weight |
| Variable | Temperature | Period | Factor | Factor | Factor |
| Value | 5° C. | 10.5 | 0.5 | 0.1 | 0.4 |
| | | hours | | | |

The present technique involves several novel features including, but not limited to, the following: (i) calculating the energy limits at each temperature using temperature sweep data and the reference temperature; (ii) transforming the temperature profile into the effective temperature profile using the rolling average period and the weighting factors; and (iii) determining the energy limits at each time along the effective profile.
The present technique could be used in the following scenario: a customer wants to see how long its thermal shipping system, which is en route, will last. The customer knows that the thermal shipping system will arrive within 24 hours and wants to know if the customer needs to send a backup in case the first thermal shipping system will not maintain the correct temperature. The customer may begin by logging into a portal operated by the present applicant and that contains software for running the present technique. The customer would then enter the tracking number for the package. The tracking number would allow the present applicant to pull data about where the package has been and when. Using location and time, the present applicant would be able to look up the weather to determine the ambient temperatures the package has been exposed to. The present applicant would also make some assumptions about what temperatures the package will face during the rest of its journey. By combining these pieces of information, the present applicant can create an ambient profile. This would then trigger a query asking for the duration of the packaging system with the newly created profile. This is the part where the above-described technique picks up. The compute device receives the profile and the system being analyzed. It would search a library for the characteristic variables and the temperature sweep data corresponding to the particular type of passive thermal shipping system being used. The system would then follow the above-described steps and return a duration prediction.
The present technique could use two reference temperatures, for example, located at opposite ends of the temperature range or could use at any two reference temperatures within the temperature range. Alternatively, there could be a single reference temperature located within the temperature range, for example, at the midpoint of the temperature range. Where two reference temperatures are used, one may simply perform the operation described above twice, with one reference temperature being used to look at potential hot failures and the other reference temperature being used to look at potential cold failures. Whichever failure comes first is reported.
The present technique could output a duration prediction and indication of whether there was a hot failure or cold failure. The present technique could also output a “battery level” which is the percentage of the energy limit the system is currently at.
Depending on the setup of the system, there may need to be additional steps taken. Such adjustments may depend on how many types of phase-change material there are in the system and whether the phase-change material temperature falls within the temperature requirements of the system. For example, water is a phase-change material having a phase-change temperature of 0° C. If water is used as the phase-change material for a system that is designed to maintain its payload within a 2° C.-8° C. range, a more complex approach may be required.
The method of the present invention accurately reproduces the results of other simulations and is thousands of times faster. Most simulation techniques solve millions of heat transfer equations to predict the temperature of an entire shipping system over its entire journey. The method of the present invention speeds the process by pre-computing the failure conditions. It also relies on simplifying assumptions to reduce the many complex heat transfer equations to a single calculation. The simplified calculation only needs to be performed several hundred times and its result compared to pre-determined failure conditions. This drastically reduces the number of computations taking place to arrive at a similar result.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A method for storing and/or transporting temperature-sensitive materials, the method comprising the steps of:
(a) selecting a first passive thermal shipping system, the first passive thermal shipping system comprising an insulated container adapted to hold the temperature-sensitive materials;
(b) compiling thermal capacitance data for the first passive thermal shipping system, the thermal capacitance data being obtained at a plurality of temperatures spanning a range of potential ambient temperatures to which the first passive thermal shipping system may be subjected during a duration of storage and/or transport;
(c) obtaining forecasted ambient temperatures to which the first passive thermal shipping system will be subjected during the duration of storage and/or transport, the forecasted ambient temperatures being spaced apart at time intervals throughout the duration of storage and/or transport;
(d) determining a failure time for the first passive thermal shipping system, wherein said failure time is a first occurrence of cumulative absorbed energy for the first passive thermal shipping system exceeding thermal capacitance for the first passive thermal shipping system;
(e) comparing the failure time for the first passive thermal shipping system to the duration of storage and/or transport, whereby, if the failure time is at least the duration of storage and/or transport, the first passive thermal shipping system is adequate for use, and, if the failure time is less than the duration of storage and/or transportation, the first passive thermal shipping system is inadequate for use;
(f) if the first passive thermal shipping system is inadequate for use, repeating steps (b), (d), and (e), as well as step (c) if a different transport/delivery route is to be taken than that of the first passive thermal shipping system, for one or more additional passive thermal shipping systems until an adequate passive thermal shipping system is identified; and
(g) storing and/or transporting the temperature-sensitive materials using the adequate passive thermal shipping system.

2. The method as claimed in claim 1 wherein the first passive thermal shipping system further comprises at least one passive temperature-control member disposed within the insulated container and wherein the at least one passive temperature-control member comprises a packaged passive temperature-control member.

3. The method as claimed in claim 1 wherein the thermal capacitance data is obtained by determining the failure time for the first passive thermal shipping system at each of the plurality of temperatures spanning the range of potential ambient temperatures to which the first passive thermal shipping may be subjected and then calculating thermal capacitance according to the following equation:
$$Thermal capacitance = ( {T}_{ambient} - {T}_{ref} ) * {t}_{failure}$$
wherein T_{ambient} represents ambient temperature, wherein T_{ref} represents a midpoint within a range of temperatures at which the payload is to be maintained, and wherein t_{failure} represents failure time at the ambient temperature.

4. The method as claimed in claim 3 wherein the thermal capacitance of step (d) is determined at an effective temperature, and wherein the effective temperature is a weighted average of the forecasted ambient temperature, a rolling average of the forecasted ambient temperature, and a cumulative average of the forecasted ambient temperature.

5. The method as claimed in claim 4 wherein the effective temperature is calculated by the following equation:
$${T}_{effective} = \frac{A * {T}_{Rolling Average} + B * {T}_{Cumulative Average} + C * {T}_{Actual Ambient}}{A + B + C}$$
wherein T_{effective} represents the effective temperature, wherein T_{Rolling Average} represents the rolling average of forecasted ambient temperatures, wherein T_{Cumulative Average} represents the cumulative average of ambient temperatures, wherein T_{Actual Ambient} represents the actual forecasted ambient temperature, and wherein A, B, and C represent weight factors.

6. The method as claimed in claim 5 wherein the cumulative absorbed energy is calculated by the following equation:
$$E ∼ {\int }_{0}^{{t}_{final}} Δ T ( t ) dt = {\int }_{0}^{{t}_{final}} {T}_{ambient} ( t ) - {T}_{ref} dt$$
wherein E is the cumulative absorbed energy up to and including a time interval, wherein t_{final} is the duration of time up to and including the time interval, wherein T_{ambient} is the forecasted ambient temperature at the time interval, and wherein T_{ref} is the midpoint of the desired temperature range for the payload.

7. The method as claimed in claim 6 wherein the failure time is determined by calculating the cumulative absorbed energy at a first time interval, calculating the thermal capacitance at a first time interval, comparing the calculated cumulative absorbed energy at the first time interval to the calculated thermal capacitance at the first time interval, and, if the cumulative absorbed energy does not exceed the thermal capacitance, repeating the calculating and comparison of the cumulative absorbed energy and the thermal capacitance for one or more successive time intervals.

8. The method as claimed in claim 6 wherein the failure time is determined by calculating each of the cumulative absorbed energy and the thermal capacitance at each time interval throughout the duration of storage and/or transportation, plotting profiles of the cumulative absorbed energy and the thermal capacitance as a function of time, and determining where the profiles intersect.

9. The method as claimed in claim 1 wherein the thermal capacitance data includes a series of intermediate thermal capacitances corresponding to temperatures between an initial temperature of the first passive thermal system and a final temperature of the first passive thermal system.

10. The method as claimed in claim 8 wherein the first passive thermal system has a reference temperature, and the reference temperature changes over time as the cumulative absorbed energy exceeds the intermediate thermal capacitances.

11. The method as claimed in claim 1 wherein one or more of steps (a) through (f) are performed using a computer.

12. The method as claimed in claim 1 further comprising the step of notifying a user whether the first passive thermal shipping system is adequate for use.

13. The method as claimed in claim 2 further comprising, after step (f) and before step (g), the steps of pre-conditioning the at least one passive temperature-control member, assembling the adequate passive thermal shipping system, and loading the payload into the adequate passive thermal shipping system.

14. The method as claimed in claim 1 wherein step (a) is performed before step (b).

15. The method as claimed in claim 1 wherein step (b) is performed before step (a).

16. A method for evaluating a passive thermal shipping system, the method comprising the steps of:
(a) compiling thermal capacitance data for the passive thermal shipping system, the thermal capacitance data being obtained at a plurality of temperatures spanning a range of potential ambient temperatures to which the passive thermal shipping system may be subjected during use;
(b) obtaining forecasted ambient temperatures to which the passive thermal shipping system will be subjected during use, the forecasted ambient temperatures being spaced apart at time intervals throughout the duration of use;
(c) determining a failure time for the passive thermal shipping system, wherein said failure time is a first occurrence of cumulative absorbed energy for the passive thermal shipping system exceeding thermal capacitance for the passive thermal shipping system; and
(d) comparing the failure time for the passive thermal shipping system to the duration of use, whereby, if the failure time is at least the duration of use, the passive thermal shipping system is adequate for use, and, if the failure time is less than the duration of use, the passive thermal shipping system is inadequate for use.

17. The method as claimed in claim 16 wherein the passive thermal shipping system further comprises at least one passive temperature-control member disposed within the insulated container and wherein the at least one passive temperature-control member comprises a packaged passive temperature-control member.

18. The method as claimed in claim 16 wherein the thermal capacitance data is obtained by determining the failure time for the passive thermal shipping system at each of the plurality of temperatures spanning the range of potential ambient temperatures to which the passive thermal shipping may be subjected and then calculating thermal capacitance according to the following equation:
$$Thermal capacitance = ( {T}_{ambient} - {T}_{ref} ) * {t}_{failure}$$
wherein T_{ambient} represents ambient temperature, wherein T_{ref} represents a midpoint within a range of temperatures at which a payload is to be maintained, and wherein t_{failure} represents failure time at the ambient temperature.

19. The method as claimed in claim 18 wherein the thermal capacitance of step (c) is determined at an effective temperature, and wherein the effective temperature is a weighted average of the forecasted ambient temperature, a rolling average of the forecasted ambient temperature, and a cumulative average of the forecasted ambient temperature.

20. The method as claimed in claim 19 wherein the effective temperature is calculated by the following equation:
$${T}_{effective} = \frac{A * {T}_{Rolling Average} + B * {T}_{Cumulative Average} + C * {T}_{Actual Ambient}}{A + B + C}$$
wherein T_{effective} represents the effective temperature, wherein T_{Rolling Average} represents the rolling average of forecasted ambient temperatures, wherein T_{Cumulative Average} represents the cumulative average of ambient temperatures, wherein T_{Actual Ambient} represents the actual forecasted ambient temperature, and wherein A, B, and C represent weight factors.

21. The method as claimed in claim 20 wherein the cumulative absorbed energy is calculated by the following equation:
$$E ∼ {\int }_{0}^{{t}_{final}} Δ T ( t ) dt = {\int }_{0}^{{t}_{final}} {T}_{ambient} ( t ) - {T}_{ref} dt$$
wherein E is the cumulative absorbed energy up to and including a time interval, wherein t_{final} is the duration of time up to and including the time interval, wherein T_{ambient} is the forecasted ambient temperature at the time interval, and wherein T_{ref} is the midpoint of the desired temperature range for the payload.

22. The method as claimed in claim 21 wherein the failure time is determined by calculating the cumulative absorbed energy at a first time interval, calculating the thermal capacitance at a first time interval, comparing the calculated cumulative absorbed energy at the first time interval to the calculated thermal capacitance at the first time interval, and, if the cumulative absorbed energy does not exceed the thermal capacitance, repeating the calculating and comparison of the cumulative absorbed energy and the thermal capacitance for one or more successive time intervals.

23. The method as claimed in claim 21 wherein the failure time is determined by calculating each of the cumulative absorbed energy and the thermal capacitance at each time interval throughout the duration of use, plotting profiles of the cumulative absorbed energy and the thermal capacitance as a function of time, and determining where the profiles intersect.

24. The method as claimed in claim 16 further comprising the step of notifying a user whether the first passive thermal shipping system is adequate for use.

25. The method as claimed in claim 16 wherein one or more of steps (a) through (d) are performed using a computer.

26. A system for use in evaluating whether a passive thermal shipping system is suitable for storage and/or transportation of temperature-sensitive materials, the system comprising:
(a) a shipper evaluator, the shipper evaluator having a central controller; and
(b) a compute device adapted for use by an inquiring party, the compute device being in electronic communication with the central controller, wherein shipment parameter data is uploaded onto the central controller using the compute device, the shipment parameter data comprising a selected passive thermal shipping system, a shipment origin, and a shipment destination;
(c) wherein the central controller retrieves data relating to an intended shipment travel path based on the shipment origin, the shipment destination, and the selected passive thermal shipping system;
(d) wherein the central controller retrieves thermal capacitance data from one or more temperature sweep tables;
(e) wherein the central controller retrieves one or more reference temperatures, a rolling average period, and weight factors for use in determining an effective ambient temperature from one or more system variable tables;
(f) wherein the central controller retrieves forecasted ambient temperature data relating to the intended shipment travel path;
(g) wherein the central controller calculates an effective ambient temperature at a plurality of time intervals along the intended shipment travel path;
(h) wherein the central controller determines a thermal capacitance at a plurality of time intervals along the intended shipment path; and
(i) wherein the central controller determines a failure time for the selected passive thermal shipping system, wherein said failure time is a first occurrence of cumulative absorbed energy for the selected passive thermal shipping system exceeding thermal capacitance for the selected passive thermal shipping system, wherein thermal capacitance is based on the effective ambient temperature.
